(19) United States
(12) Patent Application Publication
(10) Pub. No.: US 2015/0170078 A1
(43) Pub. Date: Jun. 18, 2015

(54) SYSTEM AND METHOD OF ALLOCATING LARGE NUMBERS OF TASKS

(71) Applicant: Mitchell International, Inc., San Diego, CA (US)

(72) Inventors: Basab DATTARAY, San Diego, CA (US); Scott BAIERL, San Diego, CA (US)

(73) Assignee: Mitchell International, Inc., San Diego, CA (US)

(21) Appl. No.: 14/106,325

(22) Filed: Dec. 13, 2013

(51) Int. Cl. G06Q 10/06

(52) U.S. Cl. CPC G06Q 10/06311

(57) ABSTRACT

A method of dividing a large task allocation problem is disclosed. The large task allocation problem includes a plurality of tasks and servicers. The method includes calculating an overall metric of the large task allocation problem, based at least in part on the quantity of tasks and quantity of servicers of the large task allocation problem. The method also includes dividing the large task allocation problem into a plurality of smaller task allocation problems. Each of the smaller task allocation problems includes tasks and servicers where each particular smaller task allocation problem has a problem metric calculated based at least in part on the quantity of tasks and the quantity of servicers of the particular smaller task allocation problem. The difference between the problem metric of each of the smaller task allocation problems and the overall metric of the large task allocation problem is less than a metric threshold.

### BACKGROUND

The present invention generally relates to systems and methods of allocating multiple tasks to multiple servicers, and more particularly to systems and methods of allocating tasks to servicers, where each of the tasks and each of the servicers are associated with a geographical location.

Various industries provide services to customers at different locations. For example, a real estate appraisal service provider uses a number of real estate appraisers to generate appraisals for properties at different locations on behalf of a number of real estate owners. Each day, for example, each appraiser receives a number of assignments for appraisal tasks to be performed at different locations.

The problem of determining which appraiser should receive which of the appraisal tasks is computationally complex and can require large amounts of computing resources to perform. Because the problem is NP-complete (nondeterministic polynomial time), an optimum solution may be found only by considering all possible solutions, and comparing the solutions based on a metric or rule whose outcome is to be optimized. Because all possible solutions are computed, finding the optimum solution is impractical for situations having more than a few tasks and appraisers.

The metric to be optimized may be the outcome of, for example, finishing all of the appraisal tasks as early as possible, based on estimated durations of each of the appraisal tasks and estimated durations of other activities of each of the appraisers, such as travel, documentation, and the like. In such an example, to find the optimum solution, all possible solutions are calculated, and the completion time of the last time of appraisal of all the appraisers is calculated for each of the solutions. The solution having the earliest (minimum) last completion time is then selected as the optimum solution.

The computational load for finding an optimum solution increases exponentially with the number of appraisals and the number of appraisers. Because all possible solutions are calculated, this method of distributing appraisal tasks is impractical for situations having more than a few appraisers.

### SUMMARY

One inventive aspect is a computer implemented method of dividing a large task allocation problem, where the large task allocation problem includes a plurality of tasks and servicers. The method includes calculating an overall metric of the large task allocation problem, where the overall metric is calculated based at least in part on the quantity of tasks of the large task allocation problem and the quantity of servicers of the large task allocation problem. The method also includes dividing the large task allocation problem into a plurality of smaller task allocation problems, where each of the smaller task allocation problems includes a plurality of tasks and servicers where each particular smaller task allocation problem has a problem metric calculated based at least in part on the quantity of tasks of the particular smaller task allocation problem and the quantity of servicers of the particular smaller task allocation problem. The difference between the problem metric of each of the smaller task allocation problems and the overall metric of the large task allocation problem is less than a metric threshold.

Another inventive aspect is a computer system, including a processor, and a memory, including instructions, which when executed by the process cause the computer system to perform a method of allocating a plurality of tasks to a plurality of servicers. The method includes calculating an overall metric of the large task allocation problem, where the overall metric is calculated based at least in part on the quantity of tasks of the large task allocation problem and the quantity of servicers of the large task allocation problem. The method also includes dividing the large task allocation problem into a plurality of smaller task allocation problems, where each of the smaller task allocation problems includes a plurality of tasks and servicers where each particular smaller task allocation problem has a problem metric calculated based at least in part on the quantity of tasks of the particular smaller task allocation problem and the quantity of servicers of the particular smaller task allocation problem. The difference between the problem metric of each of the smaller task allocation problems and the overall metric of the large task allocation problem is less than a metric threshold.

Another inventive aspect is a computer readable medium including non-transient instructions, which, when executed by a computer, cause the computer to perform a method of allocating a plurality of tasks to a plurality of servicers. The method includes calculating an overall metric of the large task allocation problem, where the overall metric is calculated based at least in part on the quantity of tasks of the large task allocation problem and the quantity of servicers of the large task allocation problem. The method also includes dividing the large task allocation problem into a plurality of smaller task allocation problems, where each of the smaller task allocation problems includes a plurality of tasks and servicers where each particular smaller task allocation problem has a problem metric calculated based at least in part on the quantity of tasks of the particular smaller task allocation problem and the quantity of servicers of the particular smaller task allocation problem. The difference between the problem metric of each of the smaller task allocation problems and the overall metric of the large task allocation problem is less than a metric threshold.

Other features and advantages of the disclosure may be apparent from the following description of the embodiments, which illustrate, by way of example, the principles of the present disclosure.

### BRIEF DESCRIPTION OF THE DRAWINGS

FIG. 1 is a schematic illustration of an exemplary task allocation system constructed in accordance with this disclosure.

FIG. 2 is a graphical illustration of a task allocation problem for a service provider in the FIG. 1 system.

FIG. 3 is a structured flowchart diagram illustrating a method used by a computer to allocate tasks in the FIG. 1 system.

FIG. 4 is a graphical illustration of a task allocation problem for a service provider in the FIG. 1 system.

FIG. 5 is a structured flowchart diagram illustrating an alternative method used by a computer to allocate tasks in the FIG. 1 system.

FIG. 6 is a graphical illustration of a task allocation problem for a service provider in the FIG. 1 system.

FIG. 7 is a schematic diagram of a task allocation process.

FIG. 8 is a schematic diagram of a process which divides a large task allocation problem into smaller separate task allocation problems.

FIG. 9 is a flowchart diagram illustrating a process of dividing a large task allocation problem into smaller separate task allocation problems.

FIG. 10 is a structured flowchart diagram illustrating a more detailed method used by a computer of the FIG. 1 system, such as a server, to divide a large task allocation problem into a number of smaller separate task allocation problems.

FIG. 11 illustrates an example of a task allocation problem which may be divided.

FIG. 12 illustrates a subdivided problem of FIG. 11.

FIG. 13 illustrates a subdivided problem of FIG. 12.

FIG. 14 illustrates a subdivided problem of FIG. 13.

FIG. 15 shows a configuration for a computer system constructed in accordance with the present disclosure.

### DETAILED DESCRIPTION

Particular embodiments of the invention are illustrated herein in conjunction with the drawings.

Various details are set forth herein as they relate to certain embodiments. However, the invention can also be implemented in ways which are different from those described herein. Modifications can be made to the discussed embodiments by those skilled in the art without departing from the invention. Therefore, the invention is not limited to particular embodiments disclosed herein.

In order to allocate tasks for more than a few servicers, finding an optimum solution may be impractical. However, using embodiments of systems and methods described herein, a near optimum solution may be calculated using a practical amount of computing resources and time. As discussed in further detail below, this may be accomplished by intelligently splitting a large job into a number of smaller jobs, and using a task allocation method to allocate the tasks to the resources of the smaller jobs.

Numerous industries allocate tasks among multiple servicers, and may benefit from the embodiments discussed herein. Industries such as home or building repair services, sales, claims processing, and mail or package delivery, which serve customers at different locations using multiple servicers, are particularly benefited by the embodiments discussed herein. While real estate appraisal services are discussed herein as an example, the various aspects and principles presented also apply to other industries.

In the examples, appraisers function as servicers, who are those assigned with performing the appraisal task. Each appraisal task is assigned to one of the appraisers. The appraisal tasks are allocated to each of the various appraisers by a computer system according to aspects and principles of the exemplary methods described below.

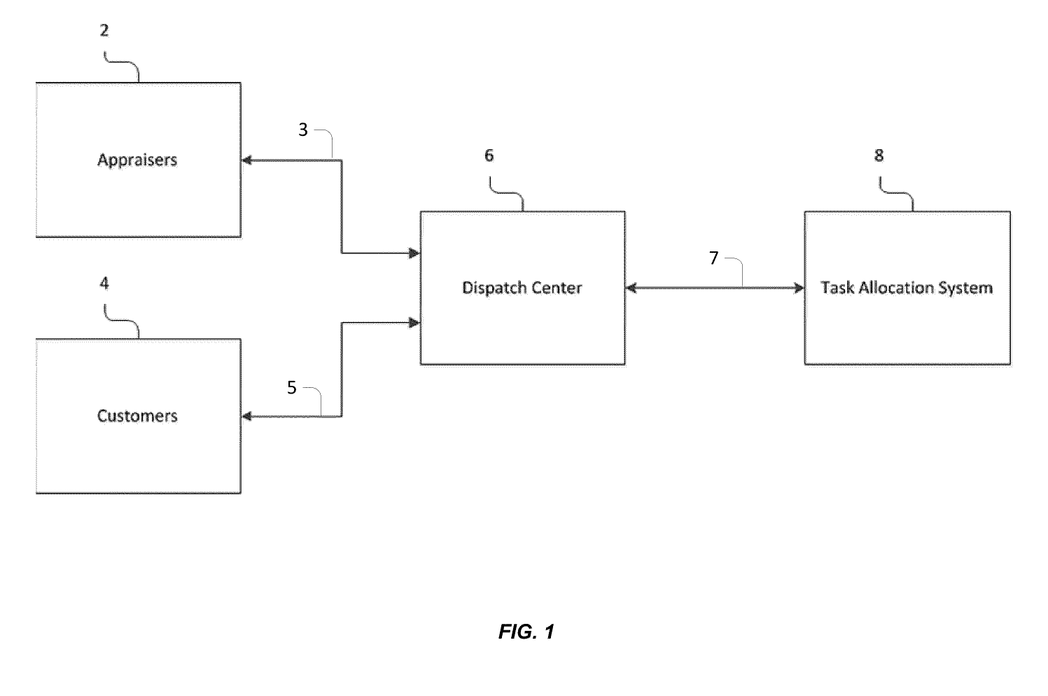

FIG. 1 is a schematic illustration of an exemplary task allocation system. The system includes appraisers 2, who provide information, for example regarding their availability, to a dispatch center 6, for example via an electronic communications network 3 connecting the two. The FIG. 1 system also includes customers 4, who request appraisal jobs from the dispatch center 6, for example via an electronic communications network 5 connecting the two. In some embodiments, the customers may include one or more insurance companies, which are in need of appraisers to assess damages for claims processing. Although the appraisers 2 are represented by a single box in FIG. 1, it should be understood that the single box 2 may represent a plurality of appraisers. Similarly, the customers 4 are represented by a single box in FIG. 1, but the single box may comprise a plurality of customers.

The dispatch center 6 receives the information from the appraisers 2 and the requests from the customers 4. The information from the multiple sources may be packaged, and delivered from the dispatch center 6 to a task allocation system 8, for example via an electronic communications network 7 connecting the two. The networks 3, 5, 7 may comprise the same network interconnecting the other components, or the networks may comprise a combination of different, public and/or private networks.

The task allocation system 8 receives the information regarding the appraisers 2 and the requested appraisal jobs or tasks for the customers 4, and performs a process to allocate the appraisal jobs or tasks among the appraisers 2. Once the allocations have been determined, the task allocation system 8 communicates the allocations to the dispatch center 6 via the network 7. The dispatch center 6 communicates the allocations for each appraiser to the respective appraisers via the network. In some embodiments, the dispatch center 6 also communicates the allocations for each customer to the respective customers via the network.

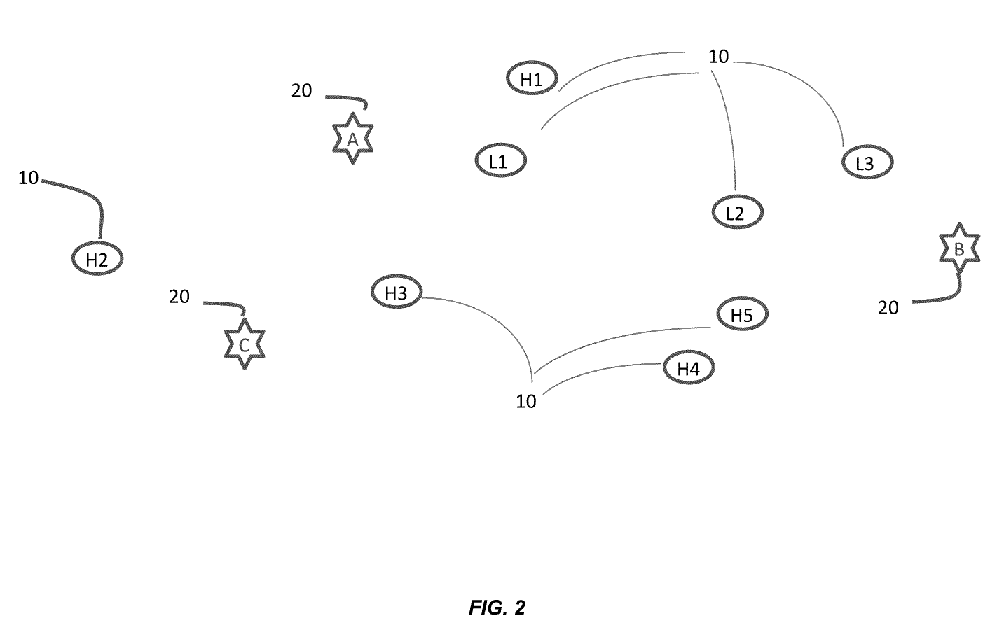

FIG. 2 is a graphical representation of a task allocation problem for a service provider such as affiliates with the FIG. 1 system. While the illustrated specific example may be small enough that an optimum solution may be practical, the FIG. 2 example is for discussion purposes, and is used to illustrate various aspects and principles that may be applied to task allocation problems that are large enough that an optimum solution is not practical.

The task allocation problem presented in FIG. 2 includes multiple appraisers 20 and multiple appraisal tasks 10, which, for example, are to be completed according to a deadline associated with the task allocation process. For example, the appraisal tasks 10 may be due for completion by a “next day” deadline. In some embodiments, tasks may be due for completion by another time period, for example, by a next hour, by a next week, or by a next month. In this FIG. 2 example, each of the appraisal tasks 10 is designated with an urgency ranking of “H” (high) or “L” (low). In addition, each of the appraisal tasks 10 is given a task number for identification, where the task number is appended to the designated urgency ranking. Accordingly, it can be seen that there are five high-urgency tasks labeled H1-H5, and there are also three low-urgency tasks labeled L1-L3. In addition, FIG. 2 shows there are three appraisers 20 labeled A, B, and C. Tasks are to be allocated to each of the appraisers 20 so that the appraisal tasks 10 may be completed the following day. References to “the appraisers” is meant to refer to all the illustrated appraisers A, B, C in the collective sense.

Each of the appraisers 20 has predetermined attributes. For example, each appraiser 20 may be associated with a geographical location, which, for example, may be their home location or their office location. In addition, each of the appraisers 20 may have a predetermined schedule, which may include fixed events, such as a meeting from 10 AM to 11 AM, and/or may include sliding events, such as a one-hour lunch break anytime between 11 AM and 1 PM, or another event having a duration, an earliest start time, and a latest end time. Additional appraiser attributes may include certifications of certain types of appraisals, or an affinity for certain customers or certain types of customers. For example, each appraiser may be required for, or may be precluded from, servicing certain customers. In some embodiments, appraiser attributes may include at least one attribute of a set of attributes: appraiser skills, work day start time, and work day end time. The appraisers 20 may have other attributes.

Each of the appraisal tasks 10 has predetermined attributes. For example, each task 10 may be associated with a geographical location at which the task is to be performed. In addition, each of the appraisal tasks 10 may have a schedule of availability, such as between 1 PM and 5 PM. Additional task attributes may include a type of appraisal, or that the property includes a pool or other special feature. Task attributes may additionally or alternatively include an affinity indicator or designator for particular appraisers. For example, each task may have a list of one or more required appraisers or precluded appraisers. In some embodiments, task attributes additionally or alternatively may include one or more of a start time, duration time, or an end time. The tasks 10 may have other attributes as well.

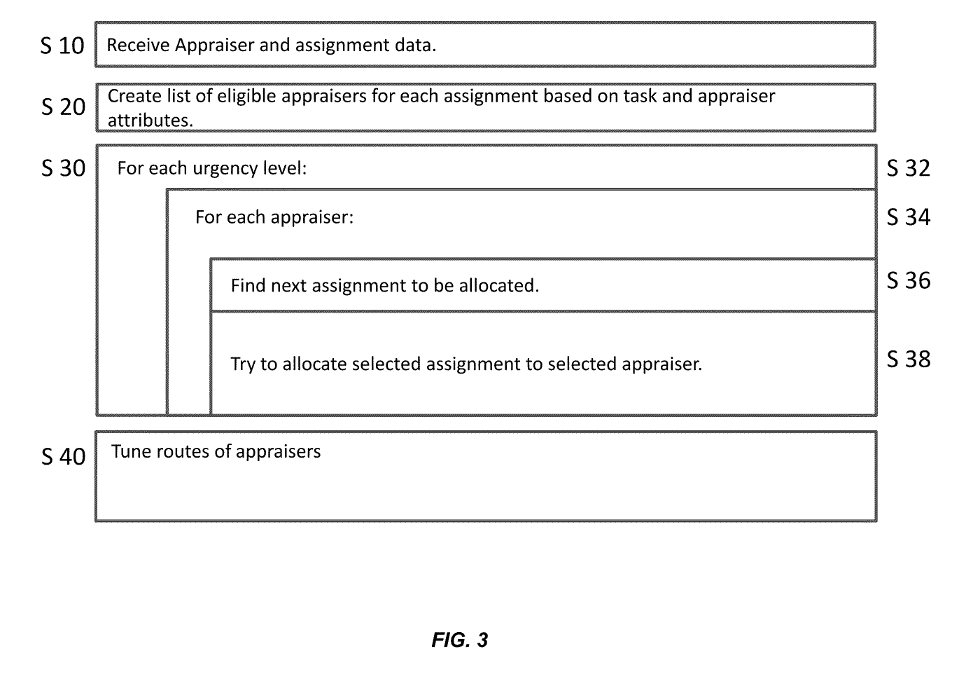

FIG. 3 is a structured flowchart diagram illustrating a method of operation implemented by a computer in the FIG. 1 system, such as a server, to allocate tasks as described herein.

In the first computer operation, the operation labeled S 10 of FIG. 3, the computer receives data associated with the tasks or assignments and the appraisers for an allocation process to be performed over a predetermined time period. The received data includes the geographical locations associated with each of the tasks and with each of the appraisers. The data also includes the appraiser attributes and the task attributes. In some embodiments, the data is tested by the computer to ensure validity and usability of the data before further proceeding.

In the operation labeled S 20, the computer generates a list of eligible appraisers for each task or assignment. For example, each task may have predetermined requirements as defined by the task attributes. In addition, based on the appraiser attributes, each appraiser has predetermined qualifications that may qualify or disqualify the appraiser from performing the task. For example, the task attributes for one of the tasks may include that the appraisal involves an electric car, and requires an appraiser with corresponding expertise, or credentials. Particular appraisers may be certified in appraising such cars. In the operation S 20, for each task or assignment, the computer generates a list of eligible appraisers based on the task attributes and the appraiser attributes. As a result, for the task of the appraisal of the electric car, only appraisers having the appropriate certification are included in the list.

In some embodiments, a metric called a “center of gravity” is calculated for each of the appraisers in the operation S 20. The center of gravity metric may be based on, for example, the geographic location of the home of the appraiser and all tasks within a specified distance of the home of the appraiser. In some embodiments, the center of gravity is calculated based at least in part on the geographic locations of a specified quantity of tasks. For example, the center of gravity may be based on the ten tasks nearest a geographic location, such as the ten tasks nearest the home of the appraiser. The center of gravity may be calculated, for example, as a geometric mean of the task locations on which the metric is based. The center of gravity may be calculated in other ways, and using other sets of data, such as transit times, terrain to be traversed, and the like.

In the operation labeled S 30, comprising an iterative loop of operations, the computer allocates tasks to appraisers based in part on the list of eligible appraisers generated in operation S 20. To do this, at step S 32, the computer determines a set of tasks beginning with the highest urgency level and continuing through each next highest urgency level. For example, in the operation S 32, the computer starts the process using tasks having the highest urgency level, and iteratively changes the urgency level towards levels of less urgency as sets of tasks are allocated. Initially, the computer may select all of the un-allocated tasks having the highest urgency level in a particular iteration, for inclusion in the set of tasks to be allocated. As a result, tasks are allocated in order of urgency, starting with the highest and proceeding to the lowest. For each set of tasks determined in the operation S 32, the computer performs the operations S 34, S 36, and S 38, as described further below. Once the computer has performed S 34, S 36, and S 38 for each of the sets of tasks determined in S 32, the computer performs the operation S 40 described below.

At the operation S 34, the computer selects a next appraiser to consider for allocation of a task. For example, the computer may select an appraiser having the lightest workload for the day. In some embodiments, the computer may select an appraiser having the lightest workload for another time duration, for example, for the past week, or for the past month. Other methods of appraiser selection may be used. After a next appraiser is selected, the computer proceeds to the operation S 36.

At the operation S 36, the computer selects a next task to be allocated from the set determined in S 32. To do this, the computer selects one of the as yet unallocated tasks of the set. In some embodiments, the selection of the unallocated task is arbitrary. In such cases, the selection may be done, for example, in numeric order, alphabetically, or according to a time associated with the tasks, such as the time of customer request.

In some embodiments, the selection is performed according to other selection criteria. For example, the computer may select the unallocated task of the set which is nearest the location of the task most recently allocated to the appraiser selected in the operation S 34, or which is nearest the location of the home of the appraiser selected in S 34 if no tasks have been previously allocated to the appraiser selected in the operation S 34.

In some embodiments, the computer selects the unallocated task of the set which is nearest the center of gravity, discussed elsewhere herein. In some embodiments, the computer selects the unallocated task of the set which is nearest the center of gravity as a first task allocated to the appraiser selected in the operation S 34. In some embodiments, subsequent unallocated tasks are selected based on proximity to the location of the task most recently allocated to the appraiser selected in the operation S 34.

In some embodiments, certain unallocated tasks may be precluded from selection based on the identity of the appraiser selected in the operation S 34. For example, if a particular unallocated tasks has been previously selected for potential allocation to the appraiser selected in S 34, a repeat selection of the particular unallocated tasks may be precluded. This may be accomplished, for example, by maintaining a list of failed allocations for each appraiser. As part of the selection process, the computer may reference the list for the appraiser selected in the operation S 34, and exclude any tasks on the list from selection.

At the operation S 38, the computer determines whether the task selected in S 36 may be allocated to the appraiser selected in S 34. To do this, the computer accesses the list of eligible appraisers generated in the operation S 20 for the task selected in S 36. If the appraiser selected at S 34 does not appear on the list of eligible appraisers for the task selected in S 36, the task is not allocatable to the appraiser selected at S 34. In response, the computer returns to S 34, where a next appraiser is selected to receive an appraisal task.

In some embodiments, the computer determines that the task selected in S 36 may not be allocated to the appraiser selected in S 34 based on other factors, not described herein. If, for any reason, the computer determines that the task selected in S 36 is not allocatable to the appraiser selected in S 34, the computer may add the task selected in S 36 to a list of failed allocations for the appraiser selected in S 34.

If, however, the appraiser selected at S 34 does appear on the list of eligible appraisers for the task selected in S 36, the computer determines whether the schedule of the appraiser selected in S 34 may accommodate the task selected in S 36. The determination may be made by comparing the schedule of the appraiser selected in S 34 with the expected task duration as included in the task attributes of the task selected in S 36, and with expected travel time calculated based on at least one of the location of a next previous task, the home of the appraiser, and a current location of the appraiser. In some embodiments, allocation of the task selected in S 36 may be conditioned on sufficient time for the appraiser selected in S 34 to travel home by a certain time after completing the task selected in S 36. In some embodiments, whether the schedule of the appraiser selected in S 34 accommodates the task selected in S 36 is based at least in part on a distance between the location of the task selected in S 36 and the center of gravity of the appraiser. If the schedule of the appraiser selected in S 34 does not accommodate the task selected in S 36, the task is not allocatable to the appraiser selected at S 34. In response, the computer returns to S 34, where a next appraiser is selected to receive a task.

If, however, the schedule of the appraiser selected in S 34 does accommodate the task selected in S 36, the computer allocates the task selected in S 36 to the appraiser selected in S 34. The computer then modifies the schedule of the appraiser selected in S 34 to include the newly allocated task. The modification is made according to task attributes of the newly allocated task. After the task is allocated, the computer returns to the operation S 34 for selection of a next appraiser to consider for task allocation.

At the conclusion of the operation S 30, each of the appraisers will have been considered for receiving tasks, and each of the tasks will have been considered for allocation. However, the scheduled sequence of the tasks allocated to each appraiser may have been determined based on the order in which the tasks were allocated. This schedule sequence may not be optimal. This is addressed in the next operation.

At the operation S 40, the task schedule for each of the appraiser is optimized. Various optimization routines may be used. In some embodiments, the locations of the tasks for an appraiser are used as a basis for optimizing the route of the appraiser. For example, the task located nearest the home of an appraiser or at the next previous task of the appraiser may be scheduled as the next task of the appraiser to be completed. In some embodiments, selection of a next task to be completed is based at least in part on a geometric analysis of a representation of the geographic locations. For each candidate next task, an angle may be determined, where the determined angle is formed between first and second line segments in the representation. The first line segment is drawn to connect the current task and the next previous task, and the second line segment is drawn to connect the current task and the candidate next task. Candidate next tasks having angles nearest 180° may be preferred in the selection process, for example by selecting the candidate next task having the angle nearest 180° or by weighting the angle with other selection factors. In some embodiments, candidate next tasks having angles nearest 0° may be preferred in the selection process.

Once the task schedule for the appraisers has been optimized, the schedule of one or more of the appraisers may have been optimized such that it could accommodate one or more additional tasks. Accordingly, in some embodiments, operations S 10 through S 40 may be repeated one or more times to add additional tasks to the routes and schedules of the appraisers.

Thus, FIG. 1 is a schematic illustration of an exemplary task allocation system, and FIG. 2 is a graphical illustration of a task allocation problem for a service provider. FIG. 3 is a structured flowchart diagram illustrating a method used by a computer of the FIG. 1 system, such as a server, to allocate tasks.

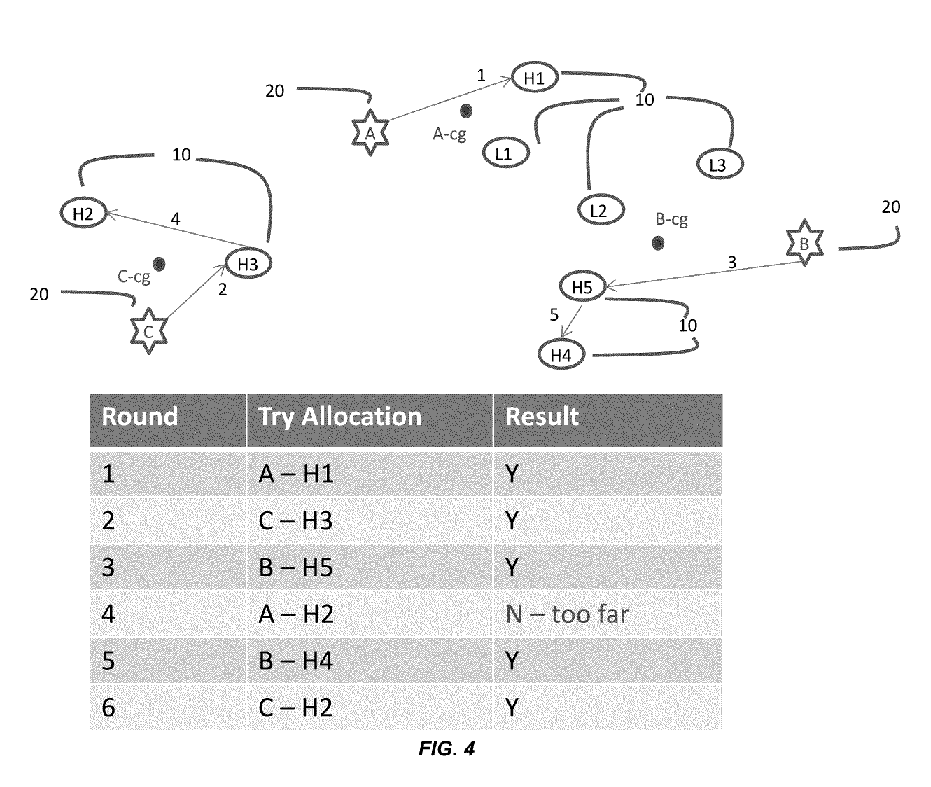

FIG. 4 is a graphical illustration of a task allocation problem for a service provider, and includes a table of operations executed by the computer in performing the method of FIG. 3 to determine a solution. The problem illustrated in FIG. 4 includes appraisers 20 and appraisal tasks 10. Each of the appraisal tasks 10 is designated with an urgency ranking of “H” (high) or “L” (low). In addition, each of the appraisal tasks 10 is designated with a task number for identification, where the task number is appended to the designated urgency ranking, as shown in FIG. 4. The table of FIG. 4 illustrates the activity at each occurrence of the operation S 38 as a computer performs the method represented by the structured flow diagram of FIG. 3. The operations of S 38 are performed iteratively, each occurrence after another. In each occurrence of the operation S 38, the computer determines whether the task previously selected in the operation S 36 may be allocated to the appraiser previously selected in the operation S 34, and allocates the task if appropriate. The computer otherwise processes the next appraiser.

Prior to the first occurrence (i.e., first iteration) of the operation S 38, the computer selects Appraiser A, and task H1, in operations S 34 and S 36, respectively. In the first occurrence of the operation S 38, represented by the data in the table for the row marked “Round 1”, the computer determines that the task H1 may be allocated to Appraiser A based on, for example, the task H1 being less than a maximum distance from the home of Appraiser A, such that Appraiser A has sufficient time to travel to task H1, complete task H1, and have a lunch break during a lunch break window of time.

The computer then repeats the operations S 34 and S 36, selecting Appraiser C and task H3. In the second occurrence of the operation S 38, represented by the data in the FIG. 4 table for the row marked “Round 2”, the computer determines that the task H3 may be allocated to Appraiser C. Likewise, the computer repeats the operations S 34 and S 36, selecting Appraiser B and task H5. In the third occurrence of the operation S 38, the computer determines that the task H5 may be allocated to Appraiser B, represented by the data for the row marked “Round 3”.

The computer then repeats the operations S 34 and S 36, selecting Appraiser A and task H2. In the fourth occurrence of S 38, the computer determines that the task H2 may not be allocated to Appraiser A based on, for example, task H2 being located greater than a maximum distance from the previous task (H1) of Appraiser A.

The computer then repeats the operations S 34 and S 36, selecting Appraiser B and task H4. In the fifth occurrence of the operation S 38, the computer determines that the task H4 may be allocated to Appraiser B. Likewise, the computer repeats operations S 34 and S 36, selecting Appraiser C and the task H2. In the sixth occurrence of the operation S 38, the computer determines that the task H2 may be allocated to Appraiser C.

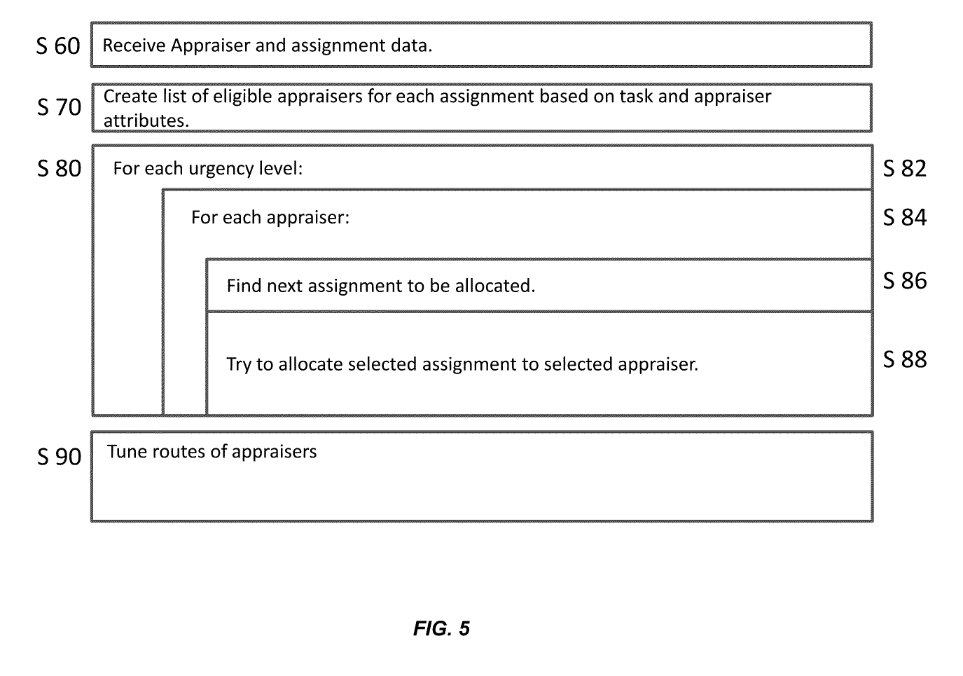

FIG. 5 is a structured flowchart diagram illustrating an alternative method used by a computer in the FIG. 1 system, such as a server, to allocate tasks using a load maximizing scheme.

In the operation S 60, the computer receives data associated with the tasks and the appraisers. The data includes the geographic locations associated with each of the tasks and with each of the appraisers. The received data also includes the appraiser attributes and the task attributes. In some embodiments, the data is tested by the computer to ensure validity and usability of the data before further proceeding.

In the operation S 70, the computer generates a list of eligible appraisers for each task. For example, each task may have certain requirements as defined by the task attributes. In addition, based on the appraiser attributes, each appraiser has certain predetermined qualifications. For example, the task attributes for one of the tasks may include that the appraisal is for an electric car. Certain appraisers may be certified in appraising such cars. In the operation S 70, for each task, the computer generates a list of eligible appraisers based on the task attributes and the appraiser attributes. As a result, for the task of the appraisal of the electric car, only appraisers having the appropriate certification are included in the list.

In some embodiments, a metric called a “center of gravity” is calculated for each of the appraisers. The center of gravity metric may be based on the geographic location of the home of the appraiser and all tasks within a specified distance of the home of the appraiser. In some embodiments, the center of gravity is calculated based at least in part on the geographic locations of a specified quantity of tasks. For example, the center of gravity may be based on the ten tasks nearest a geographic location, such as the ten tasks nearest the home of the appraiser. The center of gravity may be calculated, for example, as a geometric mean of the task locations on which the metric is based. The center of gravity may be calculated in other ways, and using other sets of data, such as transit times, terrain to be traversed, and the like.

In the operation labeled S 80, comprising an iterative loop of operations, the computer allocates tasks based in part on the list generated in the operation S 70. To do this, at the operation S 82, the computer determines a set of tasks having a next highest urgency level. For example, in the operation S 82, the computer starts the process using tasks having the highest urgency level, and changes the urgency level towards levels of less urgency as sets of tasks are allocated. For example, the computer may select all of the un-allocated tasks having the highest urgency level for inclusion in the set of tasks. As a result, tasks are allocated in order of urgency, starting with the highest. For each set of tasks determined in S 82, the computer performs the operations S 84, S 86, and S 88, as described below. Once the computer has performed the operations S 84, S 86, and S 88 for each of the sets of tasks determined in S 82, the computer performs the operation S 90 described below.

At the operation labeled S 84, the computer selects a next appraiser to consider for task allocation. For example, the computer may select an appraiser having the lightest workload for the day. In some embodiments, the computer may select an appraiser having the lightest workload for another time duration, for example, for the past week, or for the past month. Other methods of appraiser selection may be used. After a next appraiser is selected, the computer proceeds to step S 86.

At the operation labeled S 86, the computer selects a next task to be allocated from the set determined in S 82. In some embodiments, the computer modifies the set determined in S 82 such that the modified set includes only those tasks which are allocatable to the appraiser selected in the operation S 84.

To do this, the computer selects one of the as yet unallocated tasks of the set. In some embodiments, the selection of the unallocated task is arbitrary. In such cases, the selection may be done, for example, in numeric order, alphabetically, or according to a time associated with the tasks, such as the time of customer request.

In some embodiments, the selection is performed according to other selection criteria. For example, the computer may select the unallocated task of the set that is nearest the location of the task most recently allocated to the appraiser who was selected in the operation S 84, or that is nearest the location of the home of the appraiser selected in the operation S 84 if no tasks have been previously allocated to the appraiser selected in S 84.

In some embodiments, the computer selects the unallocated task of the set that is nearest the center of gravity metric, as discussed elsewhere herein. In some embodiments, the computer selects the unallocated task of the set that is nearest the center of gravity as a first task to be allocated to the appraiser selected in the operation S 84. In some embodiments, subsequent unallocated tasks are selected based on proximity to the location of the task most recently allocated to the appraiser selected in the operation S 84.

In some embodiments, unallocated tasks may be precluded from selection based on the identity of the appraiser selected in the operation S 84. For example, if a particular unallocated task has been previously selected for potential allocation to the appraiser selected in S 84, the system computer may preclude a repeat selection of the particular unallocated task. This preclusion may be accomplished, for example, by maintaining a list of failed allocations for each appraiser. As part of the selection process, the computer may reference the failed allocation list to check for the appraiser selected in S 84, and exclude any tasks on the list from selection.

At the operation labeled S 88, the computer determines whether the task selected in the operation S 86 may be allocated to the appraiser selected in S 84. To do this, the computer accesses the list of eligible appraisers generated in step S 20 for the task selected in S 86. If the appraiser selected at S 84 does not appear on the list of eligible appraisers for the task selected in S 86, the task is unallocatable to the appraiser selected at S 84. In response, the computer returns to S 84, where a next appraiser is selected to receive a task.

In some embodiments, the computer determines that the task selected in S 86 is unallocatable to the appraiser selected in S 84. If, for any reason, the computer determines that the task selected in S 86 is unallocatable to the appraiser selected in S 84, the computer may add the task selected in S 86 to a list of failed allocations for the appraiser who was selected in the operation S 84.

If, however, the appraiser selected at the operation S 84 does appear on the list of eligible appraisers for the task selected in S 86, the computer determines whether the schedule of the appraiser selected in S 84 may accommodate the task selected in S 86. The determination may be performed by comparing the schedule of the appraiser selected in S 84 with the expected task duration as included in the task attributes of the task selected in S 86, and with expected travel time calculated based on the location of a next previous task or of the home of the appraiser. In some embodiments, allocation of the task selected in S 86 may be conditioned on sufficient estimated time for the appraiser selected in S 84 to travel home by a predetermined time after completing the task selected in S 86. In some embodiments, whether the schedule of the appraiser selected in S 84 accommodates the task selected in S 86 is based at least in part on a distance between the geographic location of the task selected in S 86 and the center of gravity of the appraiser. If the schedule of the appraiser selected in S 84 does not accommodate the task selected in S 86, the task is unallocatable to the appraiser selected at S 84. In response, the computer returns to S 84, where a next appraiser is selected to receive a task.

If, however, the schedule of the appraiser selected in S 84 does accommodate the task selected in S 86, the computer allocates the task selected in S 86 to the appraiser selected in S 84. The computer then modifies the schedule of the appraiser selected in S 84 to include the newly allocated task. The modification is made according to task attributes of the newly allocated task. After the task is allocated, the computer returns to the operation S 86 for selection of a next task for allocation.

At the conclusion of the set of operations labeled S 80, each of the appraisers will have been considered for receiving tasks, and each of the tasks will have been considered for allocation. However, the scheduled sequence of the tasks allocated to each appraiser may have been determined based on the order in which the tasks were allocated. This schedule sequence may not be optimal. This is addressed in the next operation.

At the operation labeled S 90, the task schedule for each of the appraisers is optimized. Various optimization routines may be used. In some embodiments, the locations of the allocated tasks for an appraiser are used as a basis for optimizing the route of the appraiser. For example, the task located nearest the home of an appraiser or at the previous task of the appraiser may be scheduled as the next task to be completed. In some embodiments, selection of a next task to be completed is based at least in part on a geometric analysis of a representation of the geographic locations. For each candidate next task, an angle may be determined, where the determined angle is formed between first and second line segments in the representation. The first line segment is drawn to connect the current task and the next previous task, and the second line segment is drawn to connect the current task and the candidate next task. Candidate next tasks having angles nearest 180° may be selected in the selection process.

Once the task schedule for the appraisers has been optimized, the schedule of one or more of the appraisers may have been optimized such that the schedule could accommodate one or more additional tasks. Therefore, in some embodiments, the operations S 60 through S 90 may be repeated one or more times to add additional tasks to the routes and schedules of the appraisers.

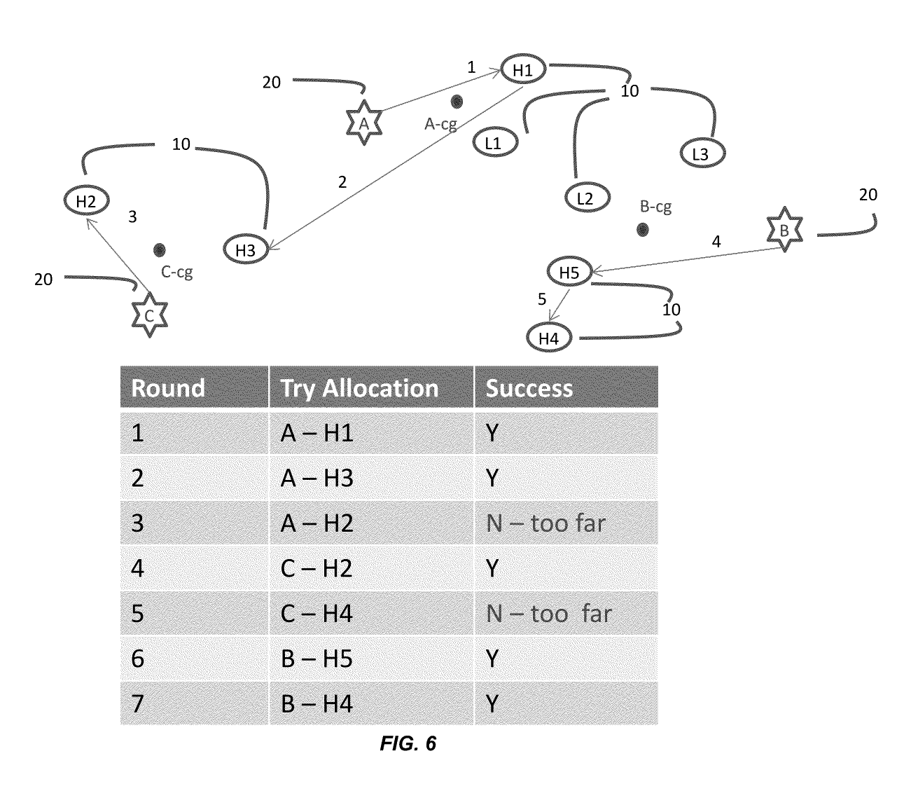

FIG. 6 is a graphical illustration of a task allocation problem for a service provider, and includes a table of operations executed by the computer in performing the method of FIG. 5 to determine a solution. The problem illustrated in FIG. 6 includes appraisers 20 and appraisal tasks 10. Each of the appraisal tasks 10 is designated with an urgency ranking of “H” (high) or “L” (low). In addition, each of the appraisal tasks 10 is designated with a task number for identification, where the task number is appended to the designated urgency ranking.

The table of FIG. 6 illustrates the activity at each occurrence of the operation labeled S 88 as a computer performs the method of FIG. 5. In each occurrence of S 88, the computer determines whether the task previously selected in the operation S 86 may be allocated to the appraiser previously selected in the operation S 84, and allocates the task if appropriate.

Prior to the first occurrence of the operation labeled S 88, the computer selects Appraiser A, and the task H1, in the operations labeled S 84 and S 86, respectively. FIG. 5 and FIG. 6 show that, in the first occurrence of S 88, the computer determines that the task H1 may be allocated to Appraiser A based on, for example, the task H1 being closest to the center of gravity of Appraiser A.

The computer then repeats the operation S 86, selecting the task H3. In the second occurrence of the operation S 88, the computer determines that the task H3 may be allocated to Appraiser A. Likewise, the computer repeats S 86, selecting the task H2. In the third occurrence of the operation S 88, the computer determines that the task H2 may not be allocated to Appraiser A.

The computer then repeats the operations S 84 and S 86, selecting Appraiser C and the task H2. In the fourth occurrence of the operation S 88, the computer determines that the task H2 may be allocated to Appraiser C. The computer then repeats the operation S 86, selecting the task H4. In the fifth occurrence of the operation S 88, the computer determines that the task H4 may not be allocated to Appraiser C.

The computer then repeats the operations S 84 and S 86, selecting Appraiser B and the task H5. In the sixth occurrence of the operation S 88, the computer determines that the task H2 may be allocated to Appraiser B. The computer then repeats S 86, selecting task H4. In the seventh occurrence of the operation S 88, the computer determines that the task H4 may be allocated to Appraiser C.

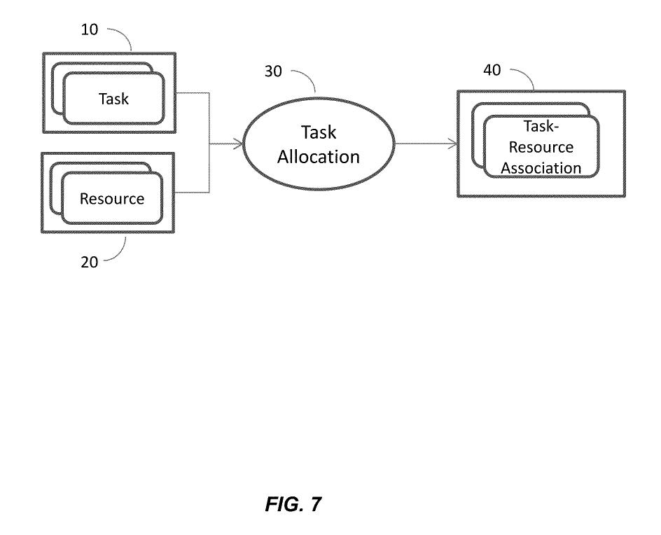

FIG. 7 is a schematic diagram of the process described above. Tasks 10 and resources 20 are inputs to task allocation process 30. As shown, task allocation process 30 generates a plurality of task-resource associations 40, where each association 40 represents an allocation of a task to a resource, such as a servicer or an appraiser.

In some embodiments, despite the reduction in computation time achieved by the systems and methods discussed above as compared with that used when finding an optimal solution, further reduction in computation time may be desirable. For example, if the number of servicers and tasks is sufficiently large, computation time may be undesirably long.

In some embodiments, a task allocation problem may be conditionally divided so as to form two or more smaller, separate task allocation problems. Each of the two or more smaller, separate task allocation problems may be solved using, for example, a method such as that described above. Other methods may be used. For example, any of the systems or methods described in U.S. patent application Ser. No. 14/070,160, titled SYSTEM AND METHOD OF AUTOMATICALLY ALLOCATING TASKS, filed Nov. 1, 2013 and assigned to the assignee of the current invention, which is incorporated herein by reference, may be used. In some embodiments an optimum solution is calculated.

In some embodiments, the separate task allocation problems are serially solved. In some embodiments, the separate task allocation problems are solved in parallel. Regardless of being solved in series or in parallel, however, the computation time is reduced by dividing the large task allocation problem. The reduction is achieved at least in part because the computation time is exponentially related to the number of servicers and tasks. Therefore, dividing a large task allocation problem in two or four, reduces the computation time by a factor greater than two or four, respectively.

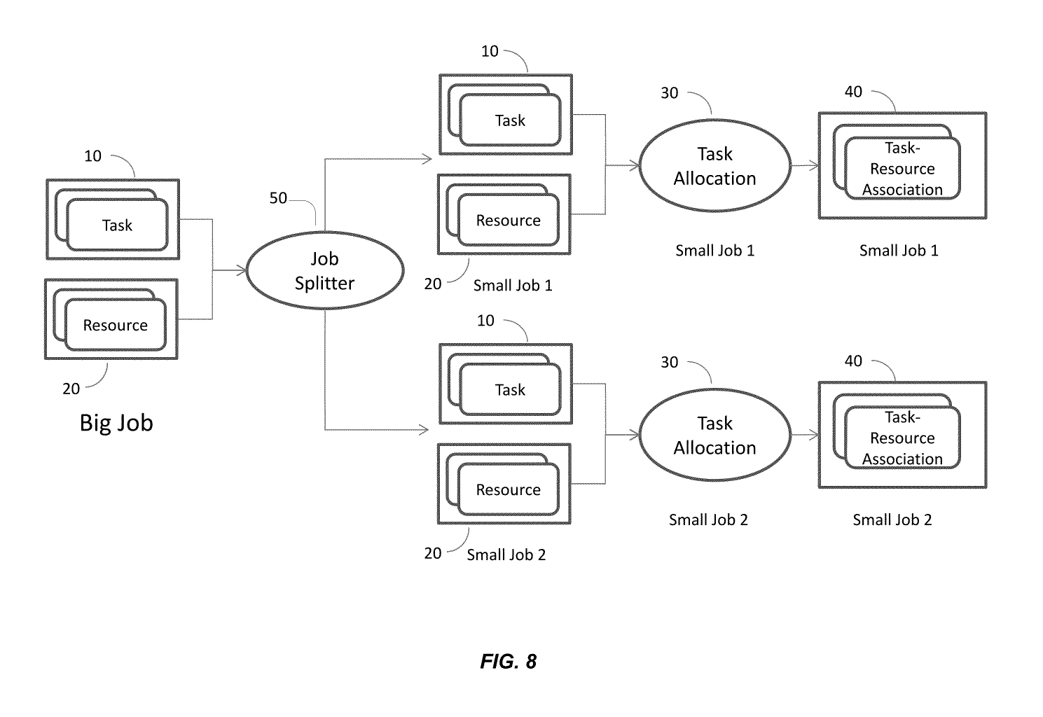

FIG. 8 is a schematic diagram of a process which divides a large task allocation problem into smaller separate task allocation problems. As shown, the tasks 10 and resources 20 associated with the big job are input to job splitter process 50. The job splitter process 50 generates two smaller jobs, a first small job 1, and a second small job 2. In addition, each of the small job 1 and small job 2 are input to task allocation processes 30, which generate task-resource associations 40 for each of small job 1 and small job 2.

In some embodiments, a large task allocation problem is divided into a number of smaller separate task allocation problems based solely on a weight, such as a quantity of one or more of tasks and servicers. For example, if a large task allocation problem includes more than a predetermined number of tasks, servicers, or tasks and servicers, then the large task allocation problem is divided into a number of smaller separate task allocation problems, such that none of the separate task allocation problems includes more than the predetermined number of tasks, servicers, or tasks and servicers.

Dividing a large task allocation problem into a number of smaller separate task allocation problems may be accomplished, for example, based on geography, such that the geographical area of the large task allocation problem is divided into a number of separate sections according to geographic area sizes. In some embodiments, each particular section is selected to have approximately the same geographical area as the other sections. That is, the geographical area of the large task allocation problem is divided into separate geographic sections having approximately the same geographic size. In some embodiments, each particular section is selected to have approximately the same weight, number of tasks, servicers, or tasks and servicers. In some embodiments, the geographical area of the large task allocation problem is divided and subdivided until no section has a weight greater than a threshold. Once divided, each particular section includes a number of tasks and servicers, which form the task allocation problem of the particular section.

In some embodiments, once the smaller separate task allocation sections and problems are defined, prior to computationally solving the allocation problems, it may be preferable to combine two or more of the smaller separate task allocation problems into groups. For example, prior to computationally solving the allocation problems, the smaller separate task allocation problems may be grouped such that the each of the groups is similar to each of the other groups, where the similarity is determined or measured by one or more metrics. For example, in some embodiments, prior to computationally solving the problems, the separate task allocation problems are grouped such that a density of each of the groups is similar to the density of each of the other groups, where density is defined as the number of tasks of the group divided by the number of tasks and servicers of the group. Other definitions of density may be used. For example, density may be defined as the number of tasks of the group divided by the number of servicers of the group. In some embodiments, density may be based on a geographical area of the group.

Once the smaller separate task allocation problems are grouped, each of the groups may be solved using, for example, a method such as one of the techniques described or referenced above. Other methods may alternatively be used.

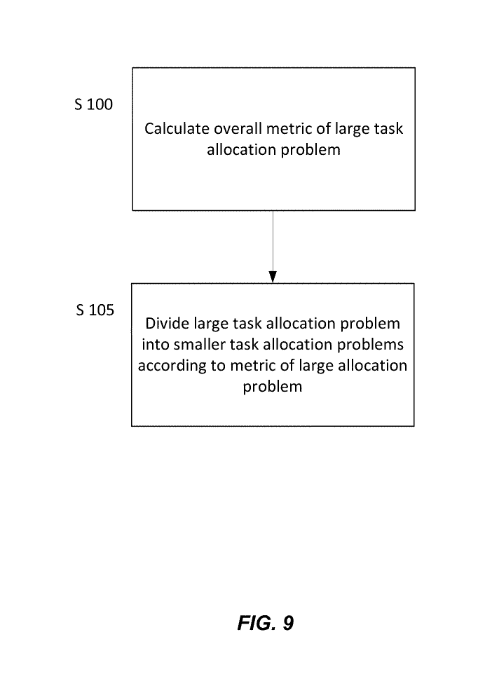

FIG. 9 is a flowchart diagram illustrating a process of dividing a large task allocation problem into smaller separate task allocation problems. In the first operation S 100, an overall metric is calculated for the large task allocation problem. For example, the overall metric may be a density, such as that described below.

In the next operation S 105, the large task allocation problem is divided into a number of smaller task allocation problems. A metric corresponding to the metric calculated in the first operation S 100 may be calculated for each of the smaller task allocation problems. In this embodiment, the large task allocation problem is divided into a number of smaller task allocation problems such that the metric calculated for each of the smaller task allocation problems is similar to the metric calculated for the large task allocation problem. For example, the absolute value of a difference between the metrics calculated for each of smaller task allocation problems and the metric calculated for the large task allocation problem is less than a threshold.

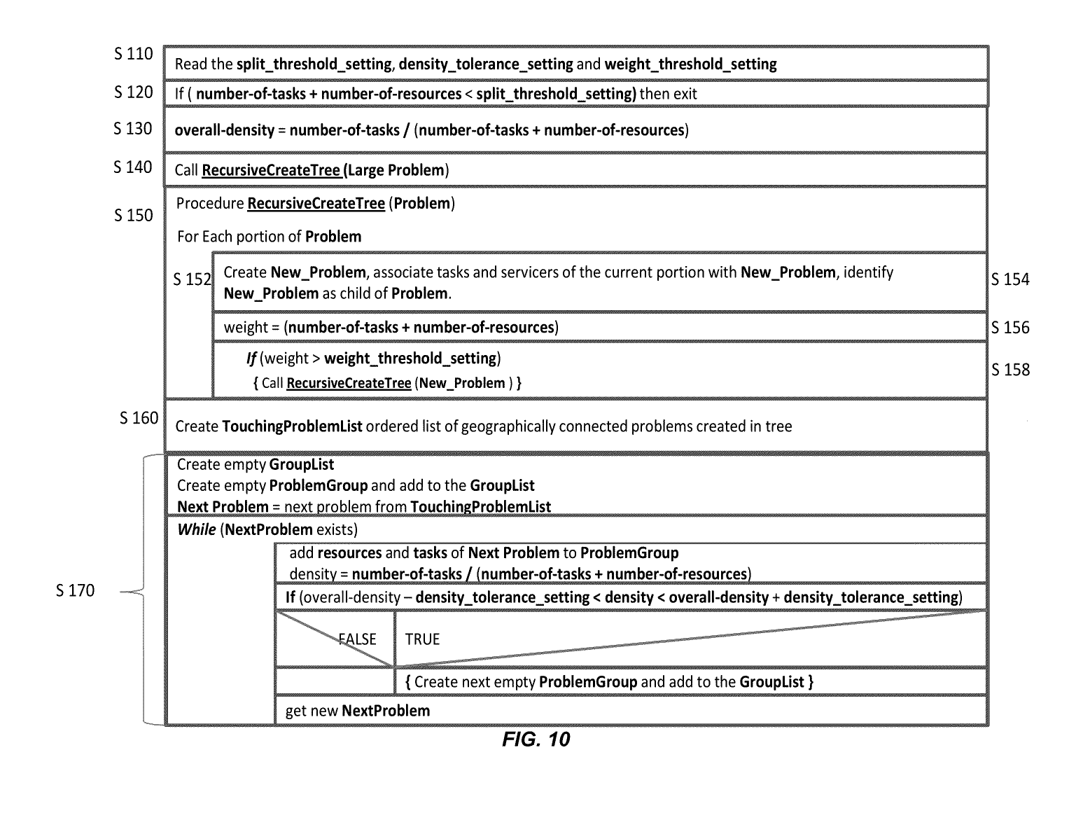

FIG. 10 is a structured flowchart diagram illustrating a more detailed method used by a computer of the FIG. 1 system, such as a server, to divide a large task allocation problem into a number of smaller separate task allocation problems.

At the operation labeled S 110, predetermined constants are accessed by the computer. The constants may include constants called split_threshold_setting, density_tolerance_setting, and weight_threshold_setting. As discussed further below, the split_threshold_setting constant is used to determine whether the large task allocation problem is sufficiently large to perform the dividing (grouping) technique described above. As discussed further below, the weight_threshold_setting constant is used to determine whether smaller separate task allocation problems are sufficiently large to further divide the groups. As discussed further below, the density_tolerance_setting constant is used to determine whether groups of problems have sufficiently similar density to proceed with the grouping technique.

At the operation labeled S 120, a determination is made as to whether the large task allocation problem is sufficiently large to divide the allocation problem. To do this, in this embodiment, a weight, defined as the number of tasks of the large task allocation problem summed with the number of resources (i.e., servicers) of the large task allocation problem, is compared to the split_threshold_setting constant. If the weight is less than the split_threshold_setting constant, then the large task allocation problem is not divided. The method otherwise continues to the operation S 130, where an overall density is calculated for the large task allocation problem. In this embodiment, the overall density is calculated as the number of tasks of the large task allocation problem divided by the number of tasks and servicers of the large task allocation problem.

At the operation S 140, a recursive procedure, which generates a problem tree, is called by the computer for execution. In the procedure call, the large task allocation problem is passed to the recursive procedure for division.

At the operation S 150, the recursive procedure is performed using the allocation problem passed thereto. In the recursive procedure, the large allocation problem is divided into a predetermined number of smaller allocation problems, as noted above. For example, the allocation problem may be divided into four smaller problems. In some embodiments, the allocation problem may be divided into two, three, five, or other number of smaller allocation problems.

In some embodiments, the number of smaller allocation problems into which the large allocation problem is divided is not predetermined, but may be dynamic. For example, the number of smaller problems into which the large problem is to be divided may be determined based on a metric indicating a size of the large problem and a limit metric indicating a desired size of the number of smaller problems after division of the allocation problem.

Each of the smaller allocation problems is based on a distinct portion of the divided problem. The operation S 152, which includes the operations S 154, S 156, and S 158, is performed for each of the portions associated with the smaller allocation problems. At the operation S 152, a new, smaller allocation problem associated with the current portion for which the operation S 152 is being performed is created and tested, to determine whether the new, smaller allocation problem should be further divided.

At the operation S 154, a new smaller allocation problem associated with the current portion for which the operation S 152 is being performed is generated. In addition, the tasks and servicers of the current portion are associated with the new smaller allocation problem. Furthermore, the new smaller allocation problem is given an identification. In some embodiments, the identification includes information indicating the new smaller problem as being a child of the larger problem being divided.

At the operation S 156, a weight for the new smaller problem is calculated. For example, the weight for the new smaller problem may be the sum of the number of tasks of the new smaller problem and the number of servicers of the new smaller problem.

At the operation S 158, if the calculated weight of the new smaller problem is greater than the weight_threshold_setting constant, then the recursive procedure is called by the computer. In the recursive procedure call, the new smaller problem is passed to the procedure for division.

Following the operation S 158, the operation S 152 is repeated for all of the new smaller allocation problems generated in the recursive procedure executed by the computer. Once completed, the recursive procedure has divided the large task allocation problem into a number of new smaller allocation problems. In addition, the procedure has given each of the new smaller problems an identity, for example, indicating a parent problem for each of the new smaller problems.

At the operation S 160, an ordered list of the new smaller allocation problems created by the recursive procedure is generated. The sequential order of the list assures that problems sequentially adjacent in the list are associated with portions of the large task allocation problem that are geographically adjacent.

At the operation S 170, a list of problem groups is generated by the computer. To generate the list, the new smaller problems created by the recursive procedure are grouped such that a density of each of the groups is similar to the density of each of the other groups, where density is defined as the number of tasks of the group divided by the number of tasks and servicers of the group.

Prior to execution of the while loop of the operation S 170, data structures stored and maintained by the computer called GroupList, ProblemGroup, and NextProblem are initialized. The GroupList, which includes the list of problem groups to be generated, is created. In addition, the ProblemGroup, which includes a group of problems, is created and added to the GroupList. Furthermore, the NextProblem is defined as the first problem in the ordered list of problems generated in the operation S 160.

In the while loop of the operation S 170, the tasks, the resources, and the geographical area of NextProblem are associated with ProblemGroup. In addition, a density for ProblemGroup is calculated, where the density is calculated as the number of tasks of ProblemGroup divided by the number of tasks and servicers of ProblemGroup.

Once the density is calculated, a determination is made to either close the ProblemGroup data structure or to add another problem to the ProblemGroup. The computer makes the determination based on the density of the ProblemGroup.

If the computer determines that the overall density calculated in the operation S 130 minus the density_tolerance_setting constant is greater than the density of ProblemGroup, or if the density of ProblemGroup is greater than the overall density calculated in the operation S 130 plus the density_tolerance_setting constant, the density of the ProblemGroup is inadequate and the ProblemGroup is not closed. The ordered list of problems generated in the operation S 160 is then accessed to define a new NextProblem, and the computer performs the while loop with the new NextProblem, and the same ProblemGroup.

If the computer determines that the overall density calculated in the operation S 130 minus the density_tolerance_setting constant is less than the density of ProblemGroup and the density of ProblemGroup is less than the overall density calculated in the operation S 130 plus the density_tolerance_setting constant, then the density of the ProblemGroup is adequate and ProblemGroup is closed by creating a new ProblemGroup and adding the new ProblemGroup to the GroupList. The ordered list of problems generated in the operation S 160 is then accessed to define a new NextProblem, and the computer performs the while loop with the new NextProblem, the new ProblemGroup, and the modified GroupList.

The operation S 170 concludes when all of the problems of the ordered list of the operation S 160 have been included in one of the groups of the list of groups. Once the list of groups has been generated, each of the groups represents a task allocation problem to be solved.

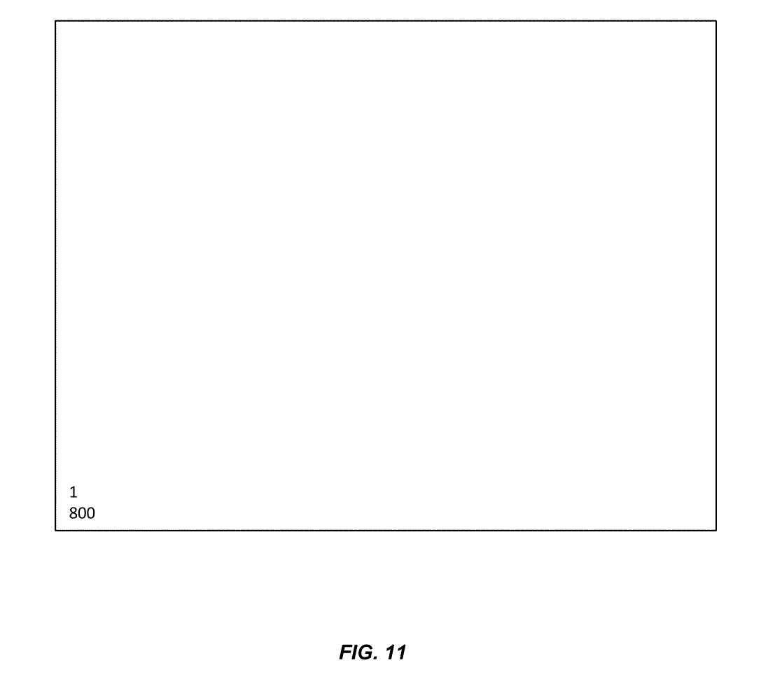

FIG. 11 illustrates an example of a task allocation problem which may be divided. In FIG. 11, a geographical area 1 has a number of tasks to be allocated to a number of resources. In this example, the total number of resources is equal to 200 resources and the total number of tasks is equal to 600 tasks, as shown in the geographical area 1. Prior to the allocation, the method illustrated in FIG. 10 may be used to conditionally divide the task allocation problem into a number of smaller, separate task allocation problems.

In this example, the split_threshold_setting constant, which the computer uses to determine whether the large task allocation problem is large enough to justify performing the dividing method, is equal to 500. In addition, the weight_threshold_setting constant, which the computer uses to determine whether smaller separate task allocation problems are large enough to justify further division, is equal to 175. Furthermore, the density_tolerance_setting constant, which the computer uses to determine whether groups of problems have sufficiently similar density, is equal to 5%. At the operation S 110, the split_threshold_setting, density_tolerance_setting, and weight_threshold_setting constants are read by the computer.

At the operation S 120, the computer performs a determination as to whether the large task allocation problem is large enough for division to significantly reduce the computation time. To do this, the computer compares the number of tasks and resources in the geographical area 1 (800 tasks and resources) to the split_threshold_setting constant (equal to 500). In this example, because the number of tasks and resources in the geographical area 1 (800) is greater than the split_threshold_setting constant (500), the task allocation problem of the geographical area 1 is divided. Accordingly, at the operation S 130, the computer calculates an overall density number for the geographical area 1. In this example, the overall density is equal to the value 600/(600+200)=0.75.

At the operation S 140, the computer calls a recursive procedure, which generates a problem tree. In the procedure call, the problem of the geographical area 1 is passed to the procedure for division.

At the operation S 150, the procedure is performed on the geographical area 1. In the procedure, the area 1 is divided into four smaller areas, each having a smaller allocation problem. The operation S 152, which includes the operations S 154, S 156, and S 158, is performed by the computer for each of the distinct portions associated with the smaller problems.

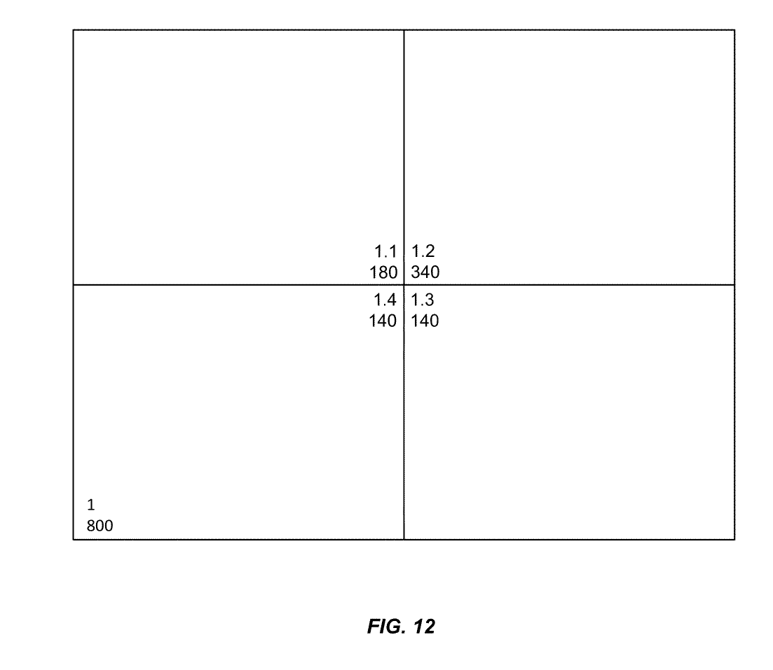

At the operation S 154, the area 1.1 is defined to be the upper right quadrant of area 1. As shown in FIG. 12, area 1.1, labeled in its lower right corner, has 130 tasks and 50 servicers.

At the operation S 156, a weight for the area 1.1 is calculated by the computer. In this example, the weight for the area 1.1 is equal to the sum of the number of tasks and resources of the area 1.1, or 180.

At the operation S 158, because the calculated weight of the area 1.1 is not greater than the weight_threshold_setting constant, which is equal 180, the recursive procedure is not called, and the computer repeats the operation S 152 for the next area, which is area 1.2.

At the operation S 154, the area 1.2 is defined to be the upper left quadrant of area 1. As shown in FIG. 12, the area 1.2, labeled in its lower left corner, has 292 tasks and 48 servicers.

At the operation S 156, a weight for the area 1.2 is calculated by the computer. In this example, the weight for the area 1.2 is equal to the sum of the number of tasks and resources of the area 1.2, or 340.

At the operation S 158, because the calculated weight of the area 1.2 is greater than the weight_threshold_setting constant, 180, the computer calls the recursive procedure. In the execution of the procedure call, the problem of the area 1.2 is passed to the procedure for division.

At the operation S 150, the procedure is performed on the geographical area 1.2. In the procedure, the area 1.2 is divided into four smaller areas, each having a smaller allocation problem. The operation S 152, which includes the operations S 154, S 156, and S 158, is performed by the computer for each of the distinct portions associated with the smaller problems.

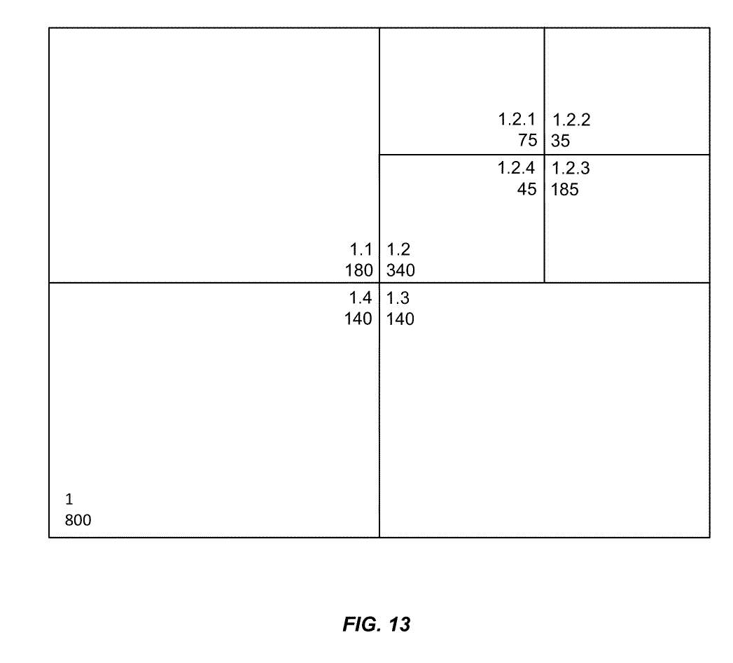

At the operation S 154, the area 1.2.1 is defined to be the upper left quadrant of the area 1.2. As shown in FIG. 13, the area 1.2.1, labeled in its lower right corner, has 63 tasks and 12 servicers.

At the operation S 156, a weight for the area 1.2.1 is calculated by the computer. In this example, the weight for the area 1.2.1 is equal to the sum of the number of tasks and resources of the area 1.2.1, or 75.

At the operation S 158, because the calculated weight of the area 1.2.1 is not greater than the weight_threshold_setting constant, which is equal 180, the recursive procedure is not called, and the computer repeats the operation S 152 for the next area, which is area 1.2.2.

At the operation S 154, the area 1.2.2 is defined to be the upper right quadrant of area 1.2. As shown in FIG. 13, the area 1.2.2, labeled in its lower left corner, has 23 tasks and 12 servicers.

At the operation S 156, a weight for the area 1.2.2 is calculated by the computer. In this example, the weight for the area 1.2.2 is equal to the sum of the number of tasks and resources of the area 1.2.2, or 35.

At the operation S 158, because the calculated weight of the area 1.2.2 is not greater than the weight_threshold_setting constant, which is equal 180, the recursive procedure is not called, and the computer repeats the operation S 152 for the next area, which is the area 1.2.3.

At the operation S 154, the area 1.2.3 is defined to be the lower right quadrant of the area 1.2. As shown in FIG. 13, the area 1.2.3, labeled in its upper left corner, has 173 tasks and 12 servicers.

At the operation S 156, a weight for the area 1.2.3 is calculated by the computer. In this example, the weight for the area 1.2.3 is equal to the sum of the number of tasks and resources of the area 1.2.3, or 185.

At the operation S 158, because the calculated weight of the area 1.2.3 is greater than the weight_threshold_setting constant, 180, the recursive procedure is called. In the call, the problem of the area 1.2.3 is passed to the procedure for division.

At the operation S 150, the procedure is performed on the geographical area 1.2.3. In the procedure, the area 1.2.3 is divided into four smaller areas, each having a smaller allocation problem. The operation S 152, which includes the operations S 154, S 156, and S 158, is performed by the computer for each of the distinct portions associated with the smaller problems.

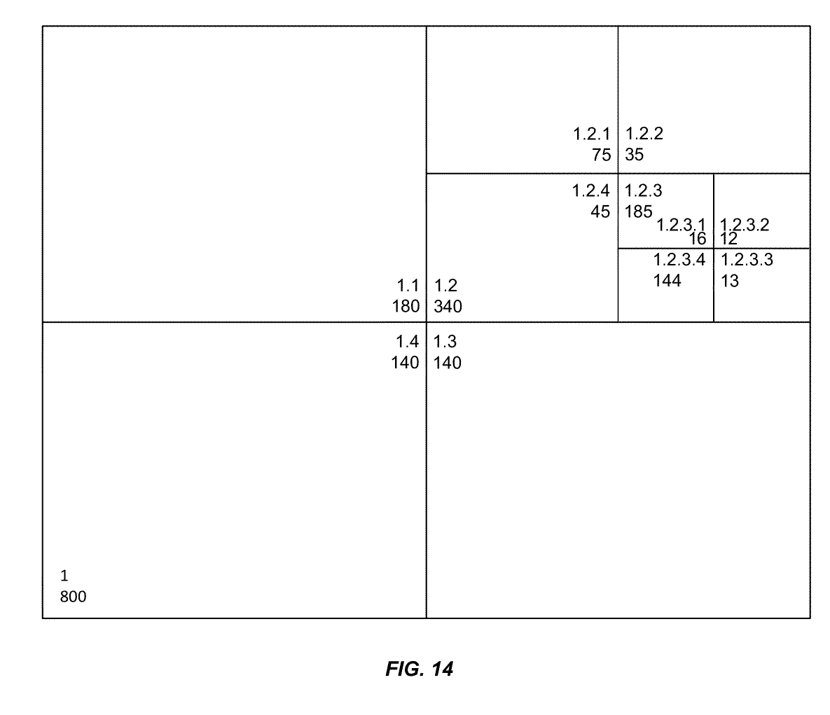

At the operation S 154, the area 1.2.3.1 is defined to be the upper left quadrant of area 1.2.3. As shown in FIG. 14, the area 1.2.3.1, labeled in its lower right corner, has 13 tasks and 3 servicers.

At the operation S 156, a weight for the area 1.2.3.1 is calculated by the computer. In this example, the weight for the area 1.2.3.1 is equal to the sum of the number of tasks and resources of the area 1.2.3.3, or 16.

At the operation S 158, because the calculated weight of the area 1.2.3.1 is not greater than the weight_threshold_setting constant, which is equal 180, the recursive procedure is not called, and the computer repeats the operation S 152 for the next area, which is the area 1.2.3.2.

At the operation S 154, the area 1.2.3.2 is defined to be the upper right quadrant of the area 1.2.3. As shown in FIG. 14, the area 1.2.3.2, labeled in its lower left corner, has 9 tasks and 2 servicers.

At the operation S 156, a weight for the area 1.2.3.2 is calculated by the computer. In this example, the weight for the area 1.2.3.2 is equal to the sum of the number of tasks and resources of the area 1.2.3.2, or 12.

At the operation S 158, because the calculated weight of the area 1.2.3.2 is less than the weight_threshold_setting constant, 180, the recursive procedure is not called, and The operation S 152 is repeated for the next area, the area 1.2.3.3.

At the operation S 154, the area 1.2.3.3 is defined to be the lower right quadrant of the area 1.2.3. As shown in FIG. 14, the area 1.2.3.3, labeled in its upper left corner, has 9 tasks and 4 servicers.

At the operation S 156, a weight for the area 1.2.3.3 is calculated by the computer. In this example, the weight for the area 1.2.3.3 is equal to the sum of the number of tasks and resources of the area 1.2.3.3, or 13.

At the operation S 158, because the calculated weight of the area 1.2.3.3 is less than the weight_threshold_setting constant, 180, the recursive procedure is not called, and the operation S 152 is repeated for the next area, the area 1.2.3.4.

At the operation S 154, the area 1.2.3.4 is defined to be the lower left quadrant of area 1.2.3. As shown in FIG. 14, area 1.2.3.4, labeled in its upper right corner, has 141 tasks and 3 servicers. The areas 1.2.3.1, 1.2.3.2, 1.2.3.3, and 1.2.3.4 are defined so that the area 1.2.3.1 is adjacent the area 1.2.2, and the area 1.2.3.4 is adjacent to the area of the area 1.2.

At the operation S 156, a weight for the area 1.2.3.4 is calculated by the computer. In this example, the weight for the area 1.2.3.4 is equal to the sum of the number of tasks and resources of the area 1.2.3.4, or 144.

At the operation S 158, because the calculated weight of the area 1.2.3.4 is less than the weight_threshold_setting constant, 180, the recursive procedure is not called, and The operation S 152 is repeated for the next area, the area 1.2.4

At the operation S 154, the area 1.2.4 is defined to be the lower left quadrant of area 1.2. As shown in FIG. 14, area 1.2.4, labeled in its upper right corner, has 33 tasks and 12 servicers. The areas 1.2.1, 1.2.2, 1.2.3, and 1.2.4 are defined so that the area 1.2.1 is adjacent the area 1.2.3.4, and the area 1.2.4 is adjacent to the area of the area 1.3.

At the operation S 156, a weight for the area 1.2.4 is calculated by the computer. In this example, the weight for the area 1.2.4 is equal to the sum of the number of tasks and resources of the area 1.2.4, or 45.

At the operation S 158, because the calculated weight of the area 1.2.4 is less than the weight_threshold_setting constant, 180, the recursive procedure is not called, and the operation S 152 is repeated for the next area, the area 1.3.

At the operation S 154, the area 1.3 is defined to be the lower right quadrant of the area 1. As shown in FIG. 14, the area 1.3, labeled in its upper left corner, has 90 tasks and 50 servicers.

At the operation S 156, a weight for the area 1.3 is calculated by the computer. In this example, the weight for the area 1.3 is equal to the sum of the number of tasks and resources of the area 1.3, or 140.

At the operation S 158, because the calculated weight of the area 1.3 is less than the weight_threshold_setting constant, 180, the recursive procedure is not called, and the operation S 152 is repeated for the next area, the area 1.4.

At the operation S 154, the area 1.4 is defined to be the lower left quadrant of area 1. As shown in FIG. 14, area 1.4, labeled in its upper right corner, has 90 tasks and 52 servicers.

At the operation S 156, a weight for the area 1.4 is calculated by the computer. In this example, the weight for the area 1.4 is equal to the sum of the number of tasks and resources of the area 1.4, or 142.

At the operation S 158, because the calculated weight of the area 1.4 is less than the weight_threshold_setting constant, 180, the recursive procedure is not called, and the area 1 has been divided into the areas illustrated in FIG. 14. In addition, the procedure has given each of the areas an identity.

At the operation S 160, an ordered list of the areas is generated. The sequential order of the list assures that the areas sequentially adjacent in the list are geographically adjacent. In this example, the list of areas is given by 1.1, 1.2.1, 1.2.2, 1.2.3.1, 1.2.3.2, 1.2.3.3, 1.2.3.4, 1.2.4, 1.3, and 1.4.

At the operation S 170, a list of allocation problem groups is generated, where each group includes one or more problems, and where each problem is associated with one of the areas of the list generated in the operation S 160. Each group of problems is solved as a single problem for the group. To generate the list of problem groups, the areas created by the recursive procedure are grouped such that a density of each of the groups is similar to the density of each of the other groups, where density, in this embodiment, is defined as the number of tasks of the group divided by the number of tasks and servicers of the group.

Prior to performing the while loop of the operation S 170, the computer initializes GroupList, ProblemGroup, and NextProblem. The GroupList, which is the list of problem groups to be generated, is created. In addition, ProblemGroup 1, which will include a group of problems, is created and added to the GroupList. Furthermore, NextProblem is defined as the allocation problem associated with the first area in the ordered list of the areas generated in the operation S 160—the area 1.1.

In the while loop of the operation S 170, the tasks, the resources, and the geographical area of the area 1.1 are associated with ProblemGroup 1. In addition, a density for ProblemGroup 1 is calculated, where the density is calculated as the number of tasks of ProblemGroup 1 divided by the number of tasks and servicers of ProblemGroup 1, or 130/(130+50)=0.72.

Once the density is calculated, a determination is made to either close ProblemGroup 1 or to add another problem to ProblemGroup 1. The determination is made based on the density of ProblemGroup 1.

In this example, the overall density calculated in the operation S 130 (0.75) minus the density_tolerance_setting constant (5% or 0.0375), or 0.7125 is not greater than the density of ProblemGroup 1 (130/(130+50)=0.72) and the density of ProblemGroup 1 is less than the overall density calculated in the operation S 130 (0.75) plus the density_tolerance_setting constant (5% or 0.0375), or 0.7875. Therefore, the density of ProblemGroup 1 is adequate and ProblemGroup 1 is closed. In addition, new ProblemGroup 2 is created, and ProblemGroup 2 is added to GroupList. The ordered list of problems generated in the operation S 160 is then accessed to define a new NextProblem as the problem associated with the area 1.2.1, the next area in the ordered list. The while loop is then performed with the new NextProblem, ProblemGroup 2, and the modified GroupList.

In the while loop of the operation S 170, the tasks, the resources, and the geographical area of the area 1.2.1 are associated with ProblemGroup 2. In addition, a density for ProblemGroup 2 is calculated, where the density is calculated as the number of tasks of ProblemGroup 2 divided by the number of tasks and servicers of ProblemGroup 2, or 63/(63+12)=0.84.

Once the density is calculated, a determination is made to either close ProblemGroup 2 or to add another problem to ProblemGroup 2. The determination is made based on the density of ProblemGroup 2.

In this example, the overall density calculated in the operation S 130 (0.75) plus the density_tolerance_setting constant (5% or 0.0375), or 0.7875, is less than the density of ProblemGroup 2 (0.84). Therefore, the density of ProblemGroup 2 is inadequate and ProblemGroup 2 is not closed. The ordered list of problems generated in the operation S 160 is then accessed to define a new NextProblem as the problem associated with the area 1.2.2, the next area in the ordered list. The while loop is then performed with the new NextProblem, and the same ProblemGroup 2.

In the while loop of the operation S 170, the tasks, the resources, and the geographical area of the area 1.2.2 are additionally associated with ProblemGroup 2. In addition, a new density for ProblemGroup 2 is calculated, where the density is calculated as the number of tasks of the areas 1.2.1 and 1.2.2 are divided by the number of tasks and servicers of the areas 1.2.1 and 1.2.2, or 86/(86+24)=0.782.

Once the density is calculated, a determination is made to either close ProblemGroup 2 or to add another problem to ProblemGroup 2. The determination is made based on the density of ProblemGroup 2.

In this example, the overall density calculated in the operation S 130 (0.75) minus the density_tolerance_setting constant (5% or 0.0375), or 0.7125 is not greater than the density of ProblemGroup 2 (0.782) and the density of ProblemGroup 2 (0.782) is not greater than the overall density calculated in the operation S 130 (0.75) plus the density_tolerance_setting constant (5% or 0.0375), or 0.7875. Therefore, the density of ProblemGroup 2 is adequate and ProblemGroup 2 is closed. In addition, new ProblemGroup 3 is created, and ProblemGroup 3 is added to GroupList. The ordered list of problems generated in the operation S 160 is then accessed to define a new NextProblem as the problem associated with the area 1.2.3.1, the next area in the ordered list. The while loop is then performed with the new NextProblem, ProblemGroup 3, and the modified GroupList.

In the execution of the while loop of the operation S 170, the tasks, the resources, and the geographical area of the area 1.2.3.1 are associated with ProblemGroup 3. In addition, a density for the ProblemGroup 3 is calculated, where the computer calculates the density as the number of tasks of the area 1.2.3.1 divided by the number of tasks and servicers of the area 1.2.3.1, or (13/(13+3) or 0.8125.

Once the density is calculated, a determination is made to either close ProblemGroup 3 or to add another problem to ProblemGroup 3. The determination is made based on the density of ProblemGroup 3.

In this example, the overall density calculated in the operation S 130 (0.75) plus the density_tolerance_setting constant (5% or 0.0375), or 0.7875, is less than the density of ProblemGroup 3 (0.8125). Therefore, the density of ProblemGroup 3 is inadequate and ProblemGroup 3 is not closed. The ordered list of problems generated in the operation S 160 is then accessed to define a new NextProblem as the problem associated with the area 1.2.3.2, the next area in the ordered list. The while loop is then performed with the new NextProblem, and the same ProblemGroup 3.

In the while loop of the operation S 170, the tasks, the resources, and the geographical area of the area 1.2.3.2 are additionally associated with ProblemGroup 3. In addition, a new density for the ProblemGroup 3 is calculated, where the computer calculates the density as the number of tasks of the areas 1.2.3.1 and 1.2.3.2 divided by the number of tasks and servicers of the areas 1.2.3.1 and 1.2.3.2, or (23/(23+5) or 0.82.

Once the density is calculated, the computer makes a determination to either close ProblemGroup 3 or add another problem to ProblemGroup 3. The determination is made based on the density of ProblemGroup 3.

In this example, the overall density calculated in the operation S 130 (0.75) plus the density_tolerance_setting constant (5% or 0.0375), or 0.7875, is less than the density of the ProblemGroup 3 (0.82). Therefore, the density of the ProblemGroup 3 is inadequate and the ProblemGroup 3 is not closed. The ordered list of problems generated in the operation S 160 is then accessed to define a new NextProblem as the problem that is associated with the area 1.2.3.3, the next area in the ordered list. The while loop is then performed with the new NextProblem, and the same ProblemGroup 3.

In the while loop of the operation S 170, the tasks, the resources, and the geographical area of the area 1.2.3.3 are additionally associated with ProblemGroup 3. In addition, a new density for the ProblemGroup 3 is calculated, where the computer calculates the density as the number of tasks of the areas 1.2.3.1, 1.2.3.2, and 1.2.3.3 divided by the number of tasks and servicers of the areas 1.2.3.1, 1.2.3.2, and 1.2.3.3, or (32/(32+9) or 0.780.

Once the density is calculated, a determination is made to either close ProblemGroup 3 or to add another problem to ProblemGroup 3. The determination is made based on the density of ProblemGroup 3.

In this example, the overall density calculated in the operation S 130 (0.75) minus the density_tolerance_setting constant (5% or 0.0375), or 0.7125 is not greater than the density of ProblemGroup 3 (0.780) and the density of ProblemGroup 3 (0.780) is not greater than the overall density calculated in the operation S 130 (0.75) plus the density_tolerance_setting constant (5% or 0.0375), or 0.7875. Therefore, the density of ProblemGroup 3 is adequate and ProblemGroup 3 is closed. In addition, new ProblemGroup 4 is created, and ProblemGroup 4 is added to GroupList. The ordered list of problems generated in the operation S 160 is then accessed to define a new NextProblem as the problem associated with the area 1.2.3.4, the next area in the ordered list. The while loop is then performed with the new NextProblem, ProblemGroup 4, and the modified GroupList.

In the while loop of the operation S 170, the tasks, the resources, and the geographical area of the area 1.2.3.4 are associated with ProblemGroup 4. In addition, a density for the ProblemGroup 4 is calculated, where the computer calculates the density as the number of tasks of the area 1.2.3.4 divided by the number of tasks and servicers of the area 1.2.3.4, or (141/(141+3) or 0.98.

Once the computer calculates the density, the computer makes a determination to either close the ProblemGroup 4 or to add another problem to the ProblemGroup 4. The computer makes the determination based on the density of the ProblemGroup 4.

In this example, the overall density calculated in the operation S 130 (0.75) plus the density_tolerance_setting constant (5% or 0.0375), or 0.7875, is less than the density of ProblemGroup 4 (0.98). Therefore, the density of ProblemGroup 4 is inadequate and ProblemGroup 4 is not closed. The ordered list of problems generated in the operation S 160 is then accessed to define a new NextProblem as the problem associated with the area 1.2.4, the next area in the ordered list. The while loop is then performed with the new NextProblem, and the same ProblemGroup 4.

In the while loop of the operation S 170, the tasks, the resources, and the geographical area of the area 1.2.4 are additionally associated with ProblemGroup 4. In addition, a new density for the ProblemGroup 4 is calculated, where the computer calculates the density as the number of tasks of the areas 1.2.3.4 and 1.2.4 divided by the number of tasks and servicers of the areas 1.2.3.4 and 1.2.4, or (174/(174+15) or 0.92.

Once the density is calculated, a determination is made to either close ProblemGroup 4 or to add another problem to ProblemGroup 4. The determination is made based on the density of ProblemGroup 4.

In this example, the overall density calculated in the operation S 130 (0.75) plus the density_tolerance_setting constant (5% or 0.0375), or 0.7875, is less than the density of ProblemGroup 4 (0.92). Therefore, the density of ProblemGroup 4 is inadequate and ProblemGroup 4 is not closed. The ordered list of problems generated in the operation S 160 is then accessed to define a new NextProblem as the problem associated with the area 1.3, the next area in the ordered list. The while loop is then performed with the new NextProblem, and the same ProblemGroup 4.

In the while loop of the operation S 170, the tasks, the resources, and the geographical area of the area 1.3 are additionally associated with ProblemGroup 4. In addition, a new density for the ProblemGroup 4 is calculated, where the computer calculates the density as the number of tasks of the areas 1.2.3.4, 1.2.4, and 1.3 divided by the number of tasks and servicers of the areas 1.2.3.4, 1.2.4, and 1.3, or (264/(264+65) or 0.80.

Once the density is calculated, a determination is made to either close ProblemGroup 4 or to add another problem to ProblemGroup 4. The determination is made based on the density of ProblemGroup 4.

In this example, the overall density calculated in the operation S 130 (0.75) plus the density_tolerance_setting constant (5% or 0.0375), or 0.7875, is less than the density of ProblemGroup 4 (0.80). Therefore, the density of ProblemGroup 4 is inadequate and ProblemGroup 4 is not closed. The ordered list of problems generated in the operation S 160 is then accessed to define a new NextProblem as the problem associated with the area 1.4, the next area in the ordered list. The while loop is then performed with the new NextProblem, and the same ProblemGroup 4.

In the while loop of the operation S 170, the tasks, the resources, and the geographical area of the area 1.4 are additionally associated with ProblemGroup 4. In addition, a new density for the ProblemGroup 4 is calculated, where the computer calculates the density as the number of tasks of the areas 1.2.3.4, 1.2.4, 1.3, and 1.4 divided by the number of tasks and servicers of the areas 1.2.3.4, 1.2.4, 1.3, and 1.4, or (264/(264+65) or 0.751.

Once the density is calculated, a determination is made to either close ProblemGroup 4 or to add another problem to ProblemGroup 4. The determination is made based on the density of ProblemGroup 4.

In this example, the overall density calculated in the operation S 130 (0.75) minus the density_tolerance_setting constant (5% or 0.0375), or 0.7125 is not greater than the density of ProblemGroup 4 (0.751) and the density of ProblemGroup 4 (0.751) is not greater than the overall density calculated in the operation S 130 (0.75) plus the density_tolerance_setting constant (5% or 0.0375), or 0.7875. Therefore, the density of ProblemGroup 4 is adequate and ProblemGroup 4 is closed. In addition, new ProblemGroup 5 is created, and ProblemGroup 5 is added to GroupList. The ordered list of problems generated in the operation S 160 is then accessed to define a new NextProblem. However, there are no additional the areas in the list, and the while loop is not performed.

The operation S 170 concludes having generated a list of problem groups, where each of the groups represents a task allocation problem to be solved. In this example, the list includes ProblemGroup 1, ProblemGroup 2, ProblemGroup 3, and ProblemGroup 4. Each of these problems may be solved using a method described or referenced herein. In some embodiments, these problems may be solved serially, and in alternative embodiments, one or more of these problems may be solved in parallel.

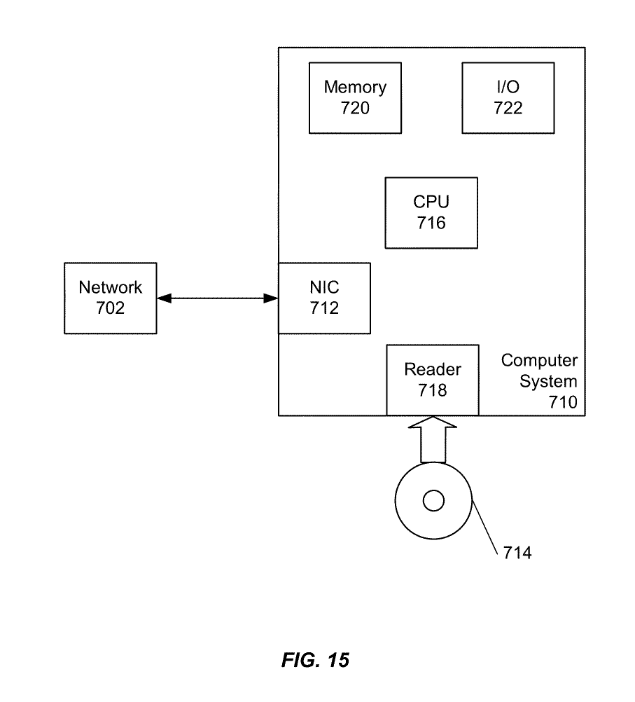

FIG. 15 shows a configuration for a computer system 710 constructed in accordance with the present disclosure to perform the operations disclosed herein. The computer system 710 can comprise a system such as a personal computer or server computer or the like. The computer system 710 may include a network communication interface 712 that permits communications with a network 702. The network interface can comprise a network interface card (NIC). The computer system 710 can execute instructions to provide a computer system which performs various aspects and principles of the methods and features described herein. For example, each of the components 2, 4, 6, 8 in FIG. 1 may be implemented by one or more of the computer systems 710.

The computer system 710 includes a central processor unit 716 (CPU) and a program product reader 718 for receiving a program product media and reading program instructions recorded thereon, where the instructions, when executed by the computer cause the computer to perform various aspects and principles of the methods and features described herein. The computer system also includes associated memory 720 and input/output facilities 722, such as a display for output and a keyboard and/or mouse for input. The processor 716 of the computer system 710 can receive program instructions into the program memory of the processor. The program instructions can be received directly, such as by flashing EEPROM of the processor, or can be received through the network interface 712, such as by download from a connected device or over a WAN or LAN network communication. If desired, the program instructions can be stored on a computer program product 714 that is read by the computer system 710 so that the program instructions can thereafter executed. That is, the program product 714 is for use in a system such as the computer system 710, wherein the program product comprises a tangible, non-transitory recordable media containing a program of computer-readable instructions that are executable by the device processor 704 to perform the operations described herein. The program product 714 can comprise, for example, optical program media such as CD or DVD data discs, or flash memory drives, or external memory stores, or floppy magnetic disks, and the like.

The present invention has been described above in terms of presently preferred embodiments so that an understanding of the present invention can be conveyed. There are, however, many configurations for network devices and management systems not specifically described herein but with which the present invention is applicable. The present invention should therefore not be seen as limited to the particular embodiments described herein, but rather, it should be understood that the present invention has wide applicability with respect to network devices and management systems generally. All modifications, variations, or equivalent arrangements and implementations that are within the scope of the attached claims should therefore be considered within the scope of the invention.

What is claimed is:

1. A computer implemented method of dividing a large task allocation problem, wherein the large task allocation problem comprises a plurality of tasks and servicers, the method comprising:
calculating an overall metric of the large task allocation problem, wherein the overall metric is calculated based at least in part on the quantity of tasks of the large task allocation problem and the quantity of servicers of the large task allocation problem;
dividing the large task allocation problem into a plurality of smaller task allocation problems, wherein each of the smaller task allocation problems comprises a plurality of tasks and servicers wherein each particular smaller task allocation problem has a problem metric calculated based at least in part on the quantity of tasks of the particular smaller task allocation problem and the quantity of servicers of the particular smaller task allocation problem, and wherein a difference between the problem metric of each of the smaller task allocation problems and the overall metric of the large task allocation problem is less than a metric threshold.

2. The method of claim 1, wherein the overall metric is equal to an overall density, and wherein the problem metrics are problem densities,
wherein the overall density is equal to the quantity of tasks of the large task allocation problem divided by the quantity of the tasks and servicers of the large task allocation problem, and
wherein the problem density of each particular smaller task allocation problem is equal to the quantity of tasks of the particular smaller task allocation problem divided by quantity of the tasks and services of the particular smaller task allocation problem.

3. The method of claim 1, wherein the geographical region of each particular smaller task allocation problem is contiguous.

4. The method of claim 1, wherein the large task allocation problem comprises a geographical region, and wherein dividing the large task allocation problem into a plurality of smaller task allocation problems comprises:
dividing the geographical region of the large task allocation problem into a plurality of sections, wherein each section has a geographical region and has one or more tasks and servicers therein, and wherein the quantity of tasks and servicers within each section is less than a quantity threshold; and
selecting one or more of the sections for each smaller task allocation problem, wherein each smaller task allocation problem comprises the tasks and servicers of the selected sections.

5. The method of claim 4, wherein dividing the geographical region of the large task allocation problem into a plurality of sections comprises:
dividing the geographical region of the large task allocation problem into four areas, wherein each area has one or more tasks and servicers therein;
determining the quantity of tasks and servicers of each particular area;
subdividing each particular area having a quantity of tasks and servicers greater than the quantity threshold into four sub-areas;
determining the quantity of tasks and servicers of each particular sub-area;
subdividing each particular sub-area having a quantity of tasks and servicers greater than the quantity threshold into four additional sub-areas;
determining the quantity of tasks and servicers of each particular additional sub-area; and
subdividing each particular sub-area having a quantity of tasks and servicers greater than the quantity threshold into four additional sub-areas, until all sub-areas have a quantity of tasks and servicers less than or equal to the quantity threshold.

6. The method of claim 5, wherein the four areas are substantially equal in size.

7. The method of claim 4, wherein selecting the sections for each smaller task allocation problem comprises:
generating an ordered list of sections;
adding a first section from the ordered list to a particular smaller task allocation problem;
calculating a problem metric for the particular smaller task allocation problem;
calculating a difference between the calculated problem metric of the particular smaller task allocation problem and the overall metric of the large task allocation problem;
in response to the calculated difference being greater than the metric threshold, adding a next section from the ordered list to the particular smaller task allocation problem; and
in response to the calculated difference being less than the metric threshold, generating a next smaller task allocation problem.

8. A computer system, comprising:
a processor; and
a memory, comprising instructions, which when executed by the process cause the computer system to perform a method of allocating a plurality of tasks to a plurality of servicers, the method comprising:
calculating an overall metric of the large task allocation problem, wherein the overall metric is calculated based at least in part on the quantity of tasks of the large task allocation problem and the quantity of servicers of the large task allocation problem;
dividing the large task allocation problem into a plurality of smaller task allocation problems, wherein each of the smaller task allocation problems comprises a plurality of tasks and servicers wherein each particular smaller task allocation problem has a problem metric calculated based at least in part on the quantity of tasks of the particular smaller task allocation problem and the quantity of servicers of the particular smaller task allocation problem, and wherein a difference between the problem metric of each of the smaller task allocation problems and the overall metric of the large task allocation problem is less than a metric threshold.

9. The computer system of claim 8, wherein the overall metric is equal to an overall density, and wherein the problem metrics are problem densities,
wherein the overall density is equal to the quantity of tasks of the large task allocation problem divided by the quantity of the tasks and servicers of the large task allocation problem, and
wherein the problem density of each particular smaller task allocation problem is equal to the quantity of tasks of the particular smaller task allocation problem divided by quantity of the tasks and services of the particular smaller task allocation problem.

10. The computer system of claim 8, wherein the geographical region of each particular smaller task allocation problem is contiguous.

11. The computer system of claim 8, wherein the large task allocation problem comprises a geographical region, and wherein dividing the large task allocation problem into a plurality of smaller task allocation problems comprises:
dividing the geographical region of the large task allocation problem into a plurality of sections, wherein each section has a geographical region and has one or more tasks and servicers therein, and wherein the quantity of tasks and servicers within each section is less than a quantity threshold; and
selecting one or more of the sections for each smaller task allocation problem, wherein each smaller task allocation problem comprises the tasks and servicers of the selected sections.

12. The computer system of claim 11, wherein dividing the geographical region of the large task allocation problem into a plurality of sections comprises:
dividing the geographical region of the large task allocation problem into four areas, wherein each area has one or more tasks and servicers therein;
determining the quantity of tasks and servicers of each particular area;
subdividing each particular area having a quantity of tasks and servicers greater than the quantity threshold into four sub-areas;
determining the quantity of tasks and servicers of each particular sub-area;
subdividing each particular sub-area having a quantity of tasks and servicers greater than the quantity threshold into four additional sub-areas;
determining the quantity of tasks and servicers of each particular additional sub-area; and
subdividing each particular sub-area having a quantity of tasks and servicers greater than the quantity threshold into four additional sub-areas, until all sub-areas have a quantity of tasks and servicers less than or equal to the quantity threshold.

13. The computer system of claim 12, wherein the four areas are substantially equal in size.

14. The computer system of claim 11, wherein selecting the sections for each smaller task allocation problem comprises:
generating an ordered list of sections;
adding a first section from the ordered list to a particular smaller task allocation problem;
calculating a problem metric for the particular smaller task allocation problem;
calculating a difference between the calculated problem metric of the particular smaller task allocation problem and the overall metric of the large task allocation problem;
in response to the calculated difference being greater than the metric threshold, adding a next section from the ordered list to the particular smaller task allocation problem; and
in response to the calculated difference being less than the metric threshold, generating a next smaller task allocation problem.

15. A computer readable medium comprising non-transient instructions, which, when executed by a computer, cause the computer to perform a method of allocating a plurality of tasks to a plurality of servicers, the method comprising:
calculating an overall metric of the large task allocation problem, wherein the overall metric is calculated based at least in part on the quantity of tasks of the large task allocation problem and the quantity of servicers of the large task allocation problem;
dividing the large task allocation problem into a plurality of smaller task allocation problems, wherein each of the smaller task allocation problems comprises a plurality of tasks and servicers wherein each particular smaller task allocation problem has a problem metric calculated based at least in part on the quantity of tasks of the particular smaller task allocation problem and the quantity of servicers of the particular smaller task allocation problem, and wherein a difference between the problem metric of each of the smaller task allocation problems and the overall metric of the large task allocation problem is less than a metric threshold.

16. The computer readable medium of claim 15, wherein the overall metric is equal to an overall density, and wherein the problem metrics are problem densities,
wherein the overall density is equal to the quantity of tasks of the large task allocation problem divided by the quantity of the tasks and servicers of the large task allocation problem, and
wherein the problem density of each particular smaller task allocation problem is equal to the quantity of tasks of the particular smaller task allocation problem divided by quantity of the tasks and services of the particular smaller task allocation problem.

17. The computer readable medium of claim 15, wherein the geographical region of each particular smaller task allocation problem is contiguous.

18. The computer readable medium of claim 15, wherein the large task allocation problem comprises a geographical region, and wherein dividing the large task allocation problem into a plurality of smaller task allocation problems comprises:
dividing the geographical region of the large task allocation problem into a plurality of sections, wherein each section has a geographical region and has one or more tasks and servicers therein, and wherein the quantity of tasks and servicers within each section is less than a quantity threshold; and
selecting one or more of the sections for each smaller task allocation problem, wherein each smaller task allocation problem comprises the tasks and servicers of the selected sections.

19. The computer readable medium of claim 18, wherein dividing the geographical region of the large task allocation problem into a plurality of sections comprises:
dividing the geographical region of the large task allocation problem into four areas, wherein each area has one or more tasks and servicers therein;
determining the quantity of tasks and servicers of each particular area;
subdividing each particular area having a quantity of tasks and servicers greater than the quantity threshold into four sub-areas;
determining the quantity of tasks and servicers of each particular sub-area;
subdividing each particular sub-area having a quantity of tasks and servicers greater than the quantity threshold into four additional sub-areas;
determining the quantity of tasks and servicers of each particular additional sub-area; and
subdividing each particular sub-area having a quantity of tasks and servicers greater than the quantity threshold into four additional sub-areas, until all sub-areas have a quantity of tasks and servicers less than or equal to the quantity threshold.

20. The computer readable medium of claim 19, wherein the four areas are substantially equal in size.

21. The computer readable medium of claim 18, wherein selecting the sections for each smaller task allocation problem comprises:
generating an ordered list of sections;
adding a first section from the ordered list to a particular smaller task allocation problem;
calculating a problem metric for the particular smaller task allocation problem;
calculating a difference between the calculated problem metric of the particular smaller task allocation problem and the overall metric of the large task allocation problem;
in response to the calculated difference being greater than the metric threshold, adding a next section from the ordered list to the particular smaller task allocation problem; and
in response to the calculated difference being less than the metric threshold, generating a next smaller task allocation problem.
